(19) United States
(12) Patent Application Publication
(10) Pub. No.: US 2026/0148729 A1
(43) Pub. Date: May 28, 2026

(54) METHOD AND APPARATUS FOR SUBSTANTIALLY TOTAL ACOUSTIC TRANSMISSION BETWEEN WATER AND AIR USING A SOLID MATERIAL

(71) Applicant: Rutgers, The State University of New Jersey, New Brunswick, NJ (US)

(72) Inventors: Andrew N. Norris, New Brunswick, NJ (US); Hesam Bakhtiary Yekta, New Brunswick, NJ (US)

(73) Assignee: Rutgers, The State University of New Jersey, New Brunswick, NJ (US)

(21) Appl. No.: 18/961,715

(22) Filed: Nov. 27, 2024

(51) Int. Cl. G10K 11/24; G10K 11/02

(52) U.S. Cl. CPC G10K 11/24; G10K 11/02

(57) ABSTRACT

A water-air acoustic interface panel or impedance matching system comprises two substantially parallel elastic plates of substantially the same length and width, including a water-facing plate and an air-facing plate; the water-facing plate and the air-facing plate being separated by a plurality of periodically spaced solid acoustic transmission mechanisms disposed therebetween and extending from a front portion of a side wall to a rear portion of the side wall, the side wall enclosing the space between the water-facing plate and the air-facing plate; the water-facing plate having a thickness h₁ and a mass density ρ₁, and the air-facing plate having a thickness h₂ and a mass density ρ₂, where h₂>h₁, and ρ₁ is substantially similar to ρ₂; the periodically spaced solid acoustic transmission mechanisms being separated from each other by a distance d, where d is selected to yield substantially full transmission of a desired frequency f₀.

### FIELD OF THE DISCLOSURE

The present disclosure generally relates to mechanisms supporting acoustic transmission between water and air.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Due to the differing impedances of water and air, typically less than 0.1% of acoustic energy (sound waves) is typically transmitted across a water/air interface. Thus, it is difficult to transmit underwater sounds to above water (air) and vice versa.

Impedance matching means for mechanical waves have been described by Hansell in U.S. Pat. No. 2,430,013. Specifically, Hansell described how impedance matching between acoustic fluids can be achieved by a quarter wavelength intermediate layer with impedance equal to the harmonic mean of the two media. The layer results in zero reflection and total energy transmission. Hansell also suggested a two layer solution, also quarter wavelength, with each impedance the harmonic mean of its neighbors; the goal of introducing two or more layers is to increase the bandwidth of the single layer resonance. Hansell's ideas saw little immediate application in acoustics; rather, the focus of impedance matching in the mid-20th century was on microwave transformers.

A later acoustics related application of impedance layers emerged for piezoelectric transducers in contact with air or water. In this case, the finite thickness of the piezoelectric element should be considered leading to, for instance, a single layer impedance

$${Z}_{air}^{2 / 3} {Z}_{piezo}^{1 / 3} .$$

Here the concern is with energy transmission between semi-infinite acoustic media so that Hansell's single layer impedance is appropriate. The difficulty lies in finding the specific material with the desired intermediate impedance, since no naturally occurring material has been found to provide the required impedance for the air-water interface.

Recent interest in impedance matching between air and water has been prompted by the approach of Bok et al. (Bok E, Park J J, Choi H, Han C K, Wright O B, Lee S H. 2018 Metasurface for Water-to-Air Sound Transmission. Phys. Rev. Lett. 120, 044302), which employs an air layer as a spring with a membrane mass in series. The Bok method and other proposed methods require air-water interfaces either through membranes, bare bubbles, bubbles within a membrane, hydrophobic materials, lotus acoustic metasurface, air channels, or metal inclusions in air and in water. Unfortunately, these approaches require a thin layer of water and/or air that is difficult if not impossible to maintain over a large surface area.

### SUMMARY

Various embodiments comprise systems, methods, mechanisms, and apparatus providing substantially total acoustic transmission between water and air (or air and water) via a passive device having a single solid element, with no fluids, or secondary air/water interfaces. Specifically, various embodiments provide an air/water interface panel comprising two or more parallel elastic plates of, illustratively, aluminum connected by solid acoustic transmission mechanisms (e.g., ribs, rows of pillars, and the like) in accordance with the design discussed herein. The interface panel separates the water and air, forming thereby an air/water interface.

In some embodiments, denoted as 2-plate embodiments, a water-air acoustic interface panel or impedance matching system comprises two substantially parallel elastic plates of substantially the same length and width, including a water-facing plate and an air-facing plate; the water-facing plate and the air-facing plate being separated by a plurality of periodically spaced ribs or rows of pillars disposed therebetween and extending from a front portion of a side wall to a rear portion of the side wall, the side wall enclosing the space between the water-facing plate and the air-facing plate; the water-facing plate having a thickness h₁ and a mass density ρ₁, and the air-facing plate having a thickness h₂ and a mass density ρ₂, where h₂>h₁, and ρ₁ is substantially similar to ρ₂; the periodically spaced ribs or rows of pillars being separated from each other by a distance d, where d is selected to yield substantially full transmission of a desired frequency f₀.

In some embodiments, denoted as 3-plate embodiments, a water-air acoustic interface panel or impedance matching system comprises three parallel elastic plates of substantially the same length and width, including a water-facing plate, an air-facing plate, and a center plate disposed therebetween; a first plurality of periodically spaced ribs or rows of pillars is disposed between the water-facing plate and center plate and extending from a front portion of a side wall to a rear portion of the side wall; a second plurality of periodically spaced ribs or rows of pillars is disposed between the center plate and air-facing plate extending from the front portion of the side wall to the rear portion of the side wall; the side wall enclosing space between the plates; the water-facing plate having a thickness h₁ and a mass density ρ₁, the air-facing plate having a thickness h₂ and a mass density ρ₂, and the center plate having a thickness h₃ and a mass density ρ₃, where h₃>>h₁>h₂, and ρ₁, ρ₂, and ρ₃ are substantially similar to each other; the periodically spaced ribs or rows of pillars for the first plurality of ribs or rows of pillars being separated from each other by a distance d₁, the periodically spaced ribs or rows of pillars for the second plurality of ribs or rows of pillars being separated from each other by a distance d₂, where d₁ and d₂ are selected to yield substantially full transmission of a desired frequency f₀. In some embodiments, d₁ is approximately equal to d₂. In some embodiments, d₁ is approximately one-half of d₂. Other and differing ratios are contemplated, such as d₁ is approximately one-quarter of d₂, or d₁ is approximately one-half or more of d₂ in some portions of the array and less than one-half of d₂ in other portions of the array.

Additional objects, advantages, and novel features of the invention will be set forth in part in the description which follows and will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a prior art spring-mass resonator separating semi-infinite water and air;

FIG. 2 graphically illustrates transmitted energy as a function of frequency for unit incident energy from the water side to the air side of the spring-mass resonator of FIG. 1, where f₀=500 Hz;

FIG. 3A depicts a side view of an air-water impedance matching system according to an embodiment;

FIG. 3B depicts a perspective view of an air-water impedance matching system according to the embodiment of FIG. 3A;

FIGS. 4A-4C graphically illustrate transmitted acoustic energy as a function of frequency for unit incident energy from the water side to the air side of various embodiments discussed with respect to FIGS. 3A-3B;

FIG. 5 graphically illustrates the relation between f₀, h₂, and d for a range of transmission frequencies of various embodiments discussed with respect to FIGS. 3A-3B;

FIG. 6A graphically illustrates the impact on transmitted acoustic energy of differing thicknesses h₁ of the first or water-facing plate of various embodiments discussed with respect to FIGS. 3A-3B;

FIG. 6B graphically illustrates the impact on transmitted acoustic energy of differing Young's modulus E₁ of the first or water-facing plate of various embodiments discussed with respect to FIGS. 3A-3B;

FIG. 7 graphically illustrates the effect of varying the thicknesses h₁ of the first or water-facing plate on Q-factor or bandwidth of various embodiments discussed with respect to FIGS. 3A-3B;

FIGS. 8A and 8B graphically illustrate plate displacements over one cycle for transmission frequency f₀=500 Hz for, respectively, first or water-facing plate and second or air-facing plate of various embodiments discussed with respect to FIGS. 3A-3B;

FIGS. 9A-9C graphically illustrate mode shape of the first or water-facing plate at full transmission for, respectively, transmission frequencies of 250 Hz, 500 Hz and 1000 Hz of various embodiments discussed with respect to FIGS. 3A-3B;

FIGS. 10A-10C graphically illustrate the effect of air between the plates as a function of rib length Lᵣ for, respectively, transmission frequencies of 250 Hz, 500 Hz and 1000 Hz of various embodiments discussed with respect to FIGS. 3A-3B;

FIG. 11A depicts a side view of an air-water impedance matching system according to a modification of the embodiments discussed with respect to FIGS. 3A-3B;

FIG. 11B depicts a perspective view of an air-water impedance matching system according to the embodiments of FIG. 11A;

FIG. 12 graphically illustrates transmission energy ratio (E) between water and air for various cases of the embodiments discussed with respect to FIGS. 11A-11B, where f₀≈500 Hz;

FIG. 13 depicts a side view of an air-water impedance matching system according to a modification of the embodiments discussed with respect to FIGS. 11A-11B;

FIG. 14 depicts a perspective view of an air-water impedance matching system according to a modification of the embodiments discussed with respect to FIGS. 3A-3B; and

FIG. 15 depicts a perspective view of an air-water impedance matching system according to a modification of the embodiments discussed with respect to FIGS. 11A-11B.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments may be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Various embodiments comprise systems, methods, mechanisms, and apparatus providing substantially total acoustic transmission between water and air (or air and water) via a passive device having a single solid element, with no fluids, or secondary air/water interfaces. Specifically, various embodiments provide an air/water interface panel comprising two sheets or plates of, illustratively, aluminum connected by periodically spaced solid acoustic transmission mechanisms such as ribs or rows of pillars in accordance with the design discussed herein. The interface panel separates the water and air, forming thereby an air/water interface.

Various embodiments provide an acoustic impedance matching mechanism for the water-air interface. A matching layer, or transformer, is made from a solid material such as aluminum, brass, light steel, and the like, and/or rigid or semi-rigid plastics such as polycarbonate, acrylic, and the like. No fluid layers, either water or air, or membranes or other mechanisms are necessary. The inventors' approach is analytically explicit, with closed form expressions relating the performance characteristics (e.g. transmission frequency) to the material properties. This enables the determining of direct relations of transformer characteristics by taking advantage of the asymptotically small parameter defined by the ratio of the air and water acoustic impedances.

As discussed in more detail below, “total” or substantially total acoustic transmission between water and air is modeled using a purely solid interface comprising two thin elastic plates (more plates may be used) separated by periodically spaced ribs (other solid acoustic transmission mechanisms may be used, such as rows of pillars). The frequency of full transmission depends only on, and is inversely proportional to, the areal density of the plate facing the air. Total transmission also requires that the rib spacing is related to the bending stiffness of the two plates. These two relations result from an explicit analytical solution for the transmitted and reflected acoustic waves combined with asymptotic approximations based on the small parameter defined by the air-to-water impedance ratio. Surprisingly, the total transmission effect is almost independent of the angle of incidence, even though the transmission conditions are predicated on normal incidence. Parametric studies are performed to examine their effect on the frequency bandwidth and Q-factor of the acoustic transmissivity. A lower bound for the Q-factor of 30.6 is simply related to the water-air impedance ratio.

Section 2 provides a simple but fundamental transformer model illustrative of the practical difficulties of air-water interfaces. A 2-plate embodiment of a flex-layer impedance transformer is presented in Section 3 along with a summary of the main results, the mathematical details of which are given in Section 4, and the conditions for total transmission are derived in Section 5. The efficacy of the embodiments in accordance with the proposed model is demonstrated in Section 6 along with discussion of factors such as the effect of entrained air between the plates, and concluding with a comparison with the fundamental one-dimensional model presented next. A summary and conclusions are given in Section 7, with 3-plate embodiments of a flex-layer impedance transformer being presented prior to Section 7.

### 2 IMPRACTICAL WATER-TO-AIR IMPEDANCE MATCHING USING WATER AND AIR LAYERS

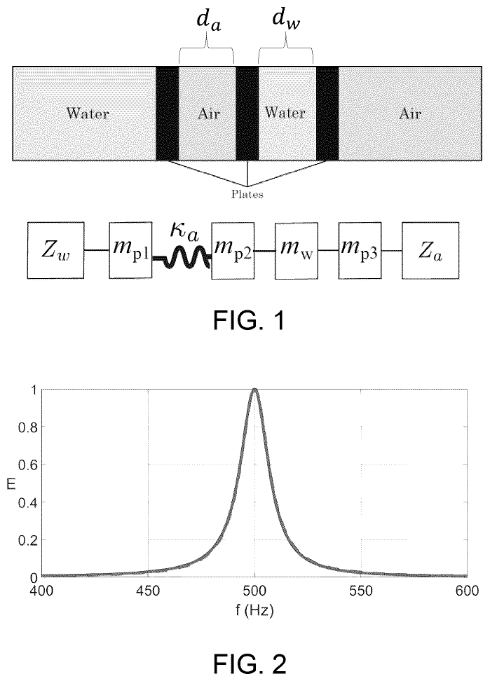

The acoustic properties of air and water are characterized by respective densities, ρₐ, ρ_{w}, and bulk moduli Kₐ, K_{w}, with derived quantities, sound speed c=\sqrt{K/ρ} and impedance Z=\sqrt{Kρ}. For example, FIG. 1 depicts a model of a prior art spring-mass resonator separating semi-infinite bodies of water and air. The semi-infinite bodies of water and air surround an impedance transformer comprising thin layers of air and water separated by thin plates, denoted for convenience as “water|air|water|air” as shown in FIG. 1. The air layer acts as the spring κₐ, and the water layer is a mass m_{w}. The central “|air|water|” impedance transformer has mass elements mₚ₁, mₚ₂, and mₚ₃ for the plates, mass element m_{w} for the water layer, and spring element κₐ for the air layer. Assuming time dependence e^{-ωt} with ω=2πf, the effective impedance of the transformer in series with the semi-infinite air can be calculated using low frequency lumped parameters models as:

$$Z = - i ω {m}_{p 1} + {\{ {( {Z}_{a} - i ω m )}^{- 1} - i {ωκ}_{a}^{- 1} \}}^{- 1} \qquad ( 1 )$$

$$where m = {m}_{w} + {m}_{p 2} + {m}_{p 3} .$$

The condition for impedance matching to water, Z=Z_{w}+0i, becomes, taking mₚ₁=0 for simplicity since it acts only as a phase term in water, as follows:

$${κ}_{a} m = {Z}_{w} {Z}_{a} , and ω \approx {ω}_{0} ≡ \frac{\sqrt{{Z}_{w} {Z}_{a}}}{m} \qquad ( 2 )$$

Condition (2) indicates that the transformer impedance \sqrt{κₐm} is the geometric mean of Z_{w} and Zₐ, which is in agreement with Hansell. Condition (2) follows from the exact solution ω=ω₀(1−∈)^{1/2} based on asymptotics for the very small parameter ∈, as follows:

$$ϵ ≡ \frac{{Z}_{a}}{{Z}_{w}} = 0.267 \times {10}^{- 3} \qquad ( 3 )$$

FIG. 2 graphically illustrates transmitted energy as a function of frequency for unit incident energy from the water side to the air side of the spring-mass resonator of FIG. 1, where f₀=500 Hz. Specifically, FIG. 2 shows a full wave simulation using transfer matrices for three 1 mm thick Al plates. Dissipation in the air layer from viscous and thermal diffusivity is included with no evident influence. Two curves are plotted, solid and dotted: the latter is an asymptotic approximation for the transmitted energy in air based on the lumped parameter model,

$$E \approx 1 / ( 1 + \frac{1}{ϵ} {( \frac{f}{{f}_{0}} - 1 )}^{2} ) .$$

The accuracy of the approximation indicates that there are no adjustable quantities in the response, even though free parameters are built into the design. This simple formula says that the Q-factor of the transmission resonance, which arises from radiation damping, not from energy dissipation, has a characteristic value of

$$Q \approx \frac{1}{2 \sqrt{ϵ}} = 30.6 .$$

Referring to FIG. 1, the central impedance transformer contemplates an air layer thickness dₐ and a water layer thickness d_{w}, which are determined according to:

$${κ}_{a} = \frac{{ρ}_{a} {c}_{a}^{2}}{{d}_{a}} , m = {ρ}_{w} {d}_{w} , \qquad ( 4 )$$

which, per condition (2), translates to the following equivalent conditions:

$$\frac{{ω}_{0} {d}_{a}}{{c}_{a}} = \sqrt{ϵ} , \frac{{d}_{w}}{{c}_{w}} = \frac{{d}_{a}}{{c}_{a}} . \qquad ( 5 )$$

The fact that \sqrt{∈}=0.016 justifies the subwavelength approximations. While the thickness of the effective water layer is adjustable, based on the choice of the plates which provide mass, the thickness of the air layer is constrained by the fact that it is the only stiffness operating, and is constrained per equation (5) as dₐ=0.87/f₀ m at f₀ Hz transmission frequency. This requires plate separation dₐ on the order of 1 mm at 870 Hz and less for higher f₀ which seems hard to imagine over large areas in water. Placing spacers between the air plates would keep the plates separated but adds stiffness in parallel which requires dₐ to be decreased. This is not a feasible solution since any parallel stiffness would overwhelm the air stiffness.

Thus, while instructive, the simple model of FIG. 1 is impractical.

### 3 2-PLATE EMBODIMENTS

Various embodiments of water-to air and air-to-water impedance matching methods and apparatus are contemplated by the inventors. For example, the disclosed embodiments contemplate the use of a pair of substantially planar and parallel elastic plates in water and separated by periodically spaced ribs, providing thereby a “flex-layer” which acts at low frequency as an equivalent stiffness. This technique contrasts with the usual low frequency approximation of an elastic solid as a mass, leading to the well-known mass-law transmission loss. The effective stiffness of the flex-layer offers a practical alternative to the air-layer stiffness of the simple model of FIG. 1, while the mass of the plates provides the necessary mass for the transmission resonance.

The flex-layer of the various embodiments may have two distinct plates, though as will be discussed in more detail below, the inventors have determined that only the plate facing the air contributes to the effective mass of the resonator.

In some embodiments, denoted as 2-plate embodiments, a water-air acoustic interface panel or impedance matching system comprises two substantially parallel elastic plates of substantially the same length and width, including a water-facing plate and an air-facing plate; the water-facing plate and the air-facing plate being separated by a plurality of periodically spaced periodically spaced solid acoustic transmission mechanisms disposed therebetween and extending from a front portion of a side wall to a rear portion of the side wall, the side wall enclosing the space between the water-facing plate and the air-facing plate; the water-facing plate having a thickness h₁ and a mass density ρ₁, and the air-facing plate having a thickness h₂ and a mass density ρ₂, where h₂>h₁, and ρ₁ is substantially similar to ρ₂; the periodically spaced periodically spaced solid acoustic transmission mechanisms being separated from each other by a distance d, where d is selected to yield substantially full transmission of a desired frequency f₀.

### 3.1 The Impedance Transformer

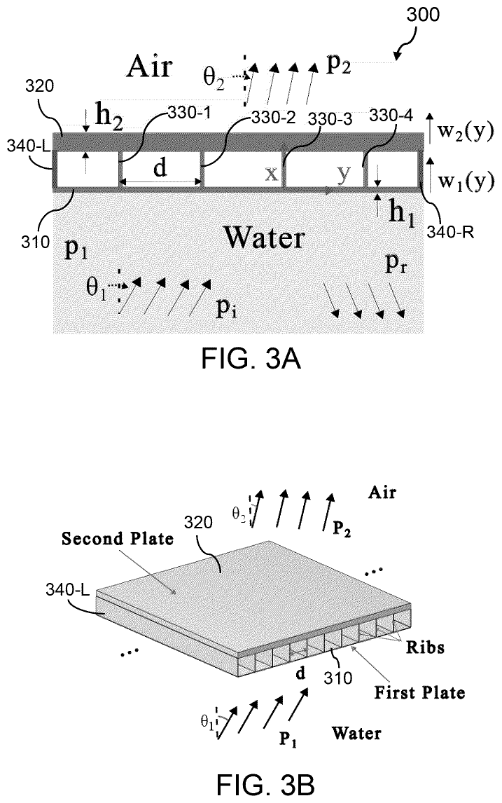

FIG. 3A depicts a side view of an air-water impedance matching system according to an embodiment, and FIG. 3B depicts a perspective view of an air-water impedance matching system according to the embodiment of FIG. 3A. Specifically, FIGS. 3A-3B depicts an air-water impedance matching system 300 comprising a pair of parallel elastic plates such as aluminum plates; namely, a first or water-facing plate 310 and a second or air-facing plate 320. Each of the parallel elastic plates 310,320 is of substantially the same length and width. The parallel elastic plates 310,320 are separated by a plurality of periodically spaced solid acoustic transmission mechanisms; namely, ribs 330 (illustratively four ribs 330-1 through 330-4) disposed therebetween and extending from a front portion 340-F (not shown) of a side wall 340 to a rear portion 340-R (not shown) of the side wall 340. While not shown in FIGS. 3A-3B, the front 340-F and rear 340-R portions of the side wall 340 would be included within an actual system, apparatus, and/or device constructed in accordance with the various embodiments.

As depicted in FIG. 3A, left 340-L and right 340-R portions of the side wall 340 are shown as being located at respective left and right edges of the system 300. In various embodiments, these left 340-L and right 340-R portions of the side wall 340 may be formed in substantially the same manner and/or of substantially the same material(s) as the ribs 330. In various embodiments, the left 340-L and right 340-R portions of the side wall 340 are implemented via leftmost and rightmost ribs 330 disposed within the impedance matching system 300.

The embodiment(s) of FIG. 3A-3B generally contemplate a square or rectilinear shaped impedance matching system (when viewed from the top or bottom). Various other embodiments may be formed using differing shapes, such as round or ovoid or triangular, etc., such as where specific shapes are appropriate for a given application.

The embodiment(s) of FIG. 3A-3B generally contemplate that the sides of the impedance matching system (of whatever shape) are enclosed via a relatively thin plate or other rigid material sufficient to keep water out of at least the operative portions of the interior of the impedance matching system.

Various embodiments contemplate that air at atmospheric pressure is allowed to remain in the voids between ribs, plates, and side walls of an impedance matching system. That is, such voids may include air or some other gas, at atmospheric pressure or above or below atmospheric pressure. In some embodiments, the voids are depressurized (e.g., during construction) by forcibly removing any air or gas to provide thereby a light to moderate vacuum.

The various embodiments of an impedance matching system are generally discussed herein as being constructed of aluminum. However, various materials may be used alone or in any combination to construct the ribs, plates, and side walls of an impedance matching system, such as aluminum, brass, light steel, and the like, and/or rigid or semi-rigid plastics such as polycarbonate, acrylic, and the like.

In various experiments, the inventor has constructed working models providing excellent performance at various transmission frequencies f₀ (e.g., 500 Hz, 1000 Hz, and so on) using aluminum plates defining water-air interfaces having substantially square or rectilinear shapes defining areas of 0.5 m², 1 m², 1.5 m², 2 m² and so on, with between 5 and twenty periodically spaced solid acoustic transmission mechanisms such as ribs. Other shapes (e.g., round, oval, and so on) and/or numbers of ribs are also suitable for use depending on the desired efficiency, transmission frequency f₀, and so on. Generally speaking, as the transmission frequencies f₀ increase, the size of the interface may decrease.

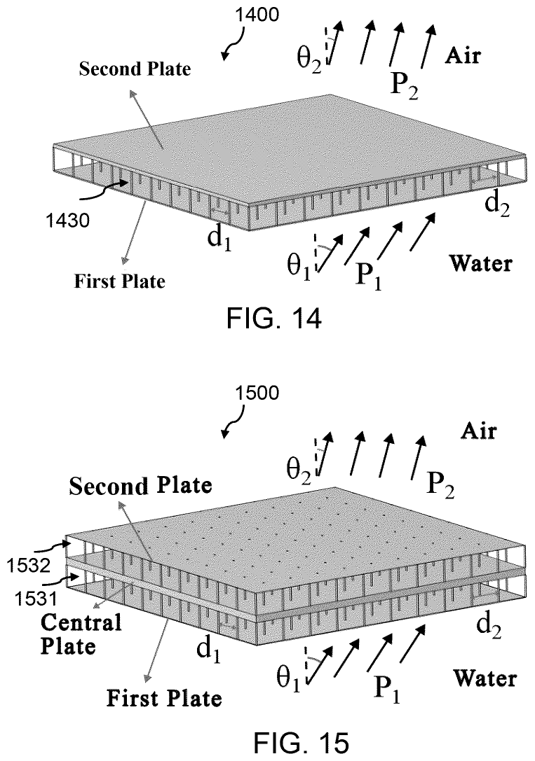

In some embodiments, rather than a plurality of ribs as the solid acoustic transmission mechanisms between the water-facing and air-facing plates, some embodiments use rows of solid pillars such as discussed in more detail below with respect to FIG. 14. Such pillars (or other solid acoustic transmission mechanisms) may be made using the same type of material as discussed herein with respect to the ribs. While the below equations and discussion are generally directed to embodiments using ribs, the equations and discussion may be adapted for other solid acoustic transmission mechanisms such as pillars and the like by one skilled in the art.

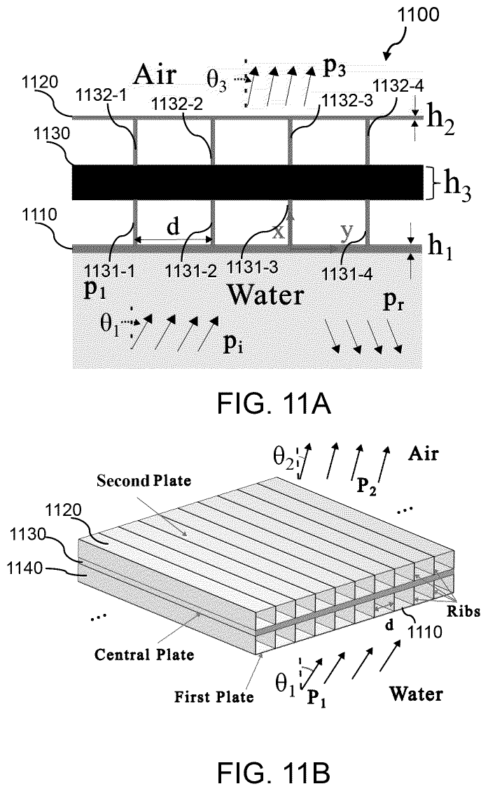

In some embodiments, a third elastic plate is used. As with the 2-plate embodiments, this third plate may be steel or other materials as previously described. It is noted that the use of the third plate provides improved bandwidth, as will be discussed in more detail below with respect to FIGS. 11A-13.

As depicted in FIG. 3A, the first 310 of the parallel elastic plates comprises a water-facing plate having a thickness h₁ and a mass density ρ₁, while the second 320 of the parallel elastic plates comprises an air-facing plate having a thickness h₂ and a mass density ρ₂, where h₂ is greater than h₁ and ρ₁ is substantially similar to ρ₂. The periodically spaced ribs are separated from each other by a distance d, where d is selected to yield substantially full transmission of a desired frequency f₀, as discussed in detail herein.

The air-water impedance matching system 300 of FIG. 3A illustrates a transformer layer in an operational state; namely, having a lower plate 310 in contact with a semi-infinite water region and an upper plate 320 in contact with a semi-infinite air region. The semi-infinite water and air regions occupy x<0 and x>0, respectively (assuming that the finite gap between the plates is compressed into a single point for simplicity).

Referring to FIG. 3A-3B, it can be seen that the water and air quantities are labelled with subscripts 1 and 2, respectively, so that the wavenumbers are kⱼ=/cⱼ where cⱼ are the sound speeds, and for later ρ_{fj} are the fluid densities. Consider plane wave incidence in water at angle θ₁ from the normal, with y-wavenumber k₀=k₁ sin θ₁. The fundamental transmitted wave in air is at angle θ₂ which follows from Snell's law: k₂ sin θ₂=k₁ sin θ₁, and hence θ₂≤θ₁.

As noted above, the impedance matching system 300 of FIG. 3A-3B comprises two parallel plates of thickness h₁ and h₂ separated by periodically spaced ribs.

The mass per unit area in each plate is mⱼ=ρⱼhⱼ and the bending stiffness is

$${D}_{j} = {E}_{j} {I}_{j} / ( 1 - {v}_{j}^{2} ) where$$

$${I}_{j} = \frac{{h}_{j}^{3}}{12} ,$$

$$j = 1 , 2 .$$

### 3.2 Conditions for Total Transmission (Principal Results)

This section summarizes the main results that define the conditions required for total transmission under normal incidence (θⱼ=0,j=1,2). The first condition necessary for full transmission relates the transmission frequency ω₀=2πf₀ to the mass densities per unit area m₁, m₂, and the acoustic impedances Zⱼ=ρ_{fj}cⱼ, j=1,2:

$${Z}_{1} + \frac{{m}_{1}^{2} {ω}_{0}^{2}}{{Z}_{1}} = {Z}_{2} + \frac{{m}_{2}^{2} {ω}_{0}^{2}}{{Z}_{2}} , \qquad ( 6 )$$

For the water-air interface Z₁=Z_{w}, Z₂=Zₐ, this reduces to:

$${ω}_{0} \approx \frac{\sqrt{{Z}_{w} {Z}_{a}}}{{m}_{2}} \qquad ( 7 )$$

which is precise if m₁=m₂ and is otherwise less than 0.1% in error. It is interesting to compare this with the condition (2) for the simple model of FIG. 1, which also depends upon the mass facing the air half-space.

The second condition involves solving for the zero of a nonlinear function, although the solution can be approximated (see Section 6) for the air-water interface by a relation similar to (2)₁ for the simple transformer model

$$κ {m}_{2} \approx {Z}_{a} {Z}_{w} where \qquad ( 8 )$$

$$κ = \frac{720}{{d}^{4}} {( \frac{1}{{D}_{1}} + \frac{1}{{D}_{2}} )}^{- 1} .$$

In practice, (8) provides the condition for determining the rib spacing d that yields full transmission at ω=ω₀ of (7). In summary, the flex-layer acts as a spring-mass transformer with stiffness κ that depends on the stiffness of both plates and mass m=m₂ that depends only on the mass of the plate on the air side.

### 4 SCATTERING ANALYSIS FOR AN ASYMMETRIC PANEL

On the water side, plate 1<x<0, we consider the incident acoustic pressure p₁ along with its rigidly reflected pressure, which together give zero normal velocity on the plate. The plate normal velocity, ν₁(y)=νₓ(−0,y) is therefore related to the additional pressure p₁ by the momentum equilibrium equation in the x-direction:

$${i ωρ}_{f 1} {v}_{1} ( y ) = \frac{\partial {p}_{1}}{\partial x} ( 0 , y ) .$$

On the air side the total acoustic pressure p=p₂ radiates away from the plate in the positive x-direction, and the plate normal velocity, ν₂(y)=νₓ(+0,y), is given by

$${i ωρ}_{f 2} {v}_{2} ( y ) = \frac{\partial {p}_{2}}{\partial x} ( 0 , y ) .$$

Introducing the y-transforms,

$${\hat{V}}_{j} ( ξ ) = {\int }_{- ∞}^{∞} {v}_{j} ( y ) {e}^{- i ξ y} dy , \qquad ( 9 )$$

$${v}_{j} ( y ) = \frac{1}{2 π} {\int }_{- ∞}^{∞} {\hat{V}}_{j} ( ξ ) {e}^{i ξ y} d ξ ,$$

$$j = 1 , 2 ,$$

it follows that the additional scattered pressure in the water (j=1) and the total pressure in the air (j=2) are related to the normal velocities by

$${p}_{j} ( x , y ) = \frac{sgn x}{2 π} {\int }_{- ∞}^{∞} {\hat{Z}}_{fj} ( ξ ) {\hat{V}}_{j} ( ξ ) {e}^{i ( \sqrt{{k}_{j}^{2} - {ξ}^{2}} \vert x \vert + ξy )} d ξ , \qquad ( 10 )$$

$$j = 1 , 2$$

where the fluid impedances are

$${\hat{Z}}_{fj} ( ξ ) = \frac{{ρ}_{fj} ω}{\sqrt{{k}_{j}^{2} - {ξ}^{2}}} , \qquad ( 11 )$$

$$j = 1 , 2.$$

The square roots in equations (10) and (11) are either positive real or positive imaginary. In summary, the total pressure in water (x<0) and air (x>0) is

$$p ( x , y ) = \{ \begin{matrix}{p}_{1} ( x , y ) + {p}_{0} {e}^{{ik}_{1} ( {xcos θ}_{1} + {ysin θ}_{1} )} + {p}_{0} {e}^{{ik}_{1} ( - {xcos θ}_{1} + {ysin θ}_{1} )} , & x < 0 , \\ {p}_{2} ( x , y ) , & x > 0 ,\end{matrix} \qquad ( 12 )$$

with p₁ and p₂ given by eq. (10).

### 4.1 Solution

The displacements of plates 1 and 2 in the x-direction, wⱼ(y)=(−iω)⁻¹νⱼ(y), satisfy the following conditions:

$${ℒ}_{1} {w}_{1} ( y ) = 2 {p}_{0} {e}^{i {k}_{0} y} + {p}_{1} ( 0 , y ) - [ {Z}_{0 +} ( {v}_{2} + {v}_{1} ) ( y ) - {Z}_{0 -} ( {v}_{2} - {v}_{1} ) ( y ) ] {\sum }_{l = - ∞}^{∞} δ ( y - ld ) \qquad ( 13 )$$

$${ℒ}_{2} {w}_{2} ( y ) = - {p}_{2} ( 0 , y ) - [ {Z}_{0 +} ( {v}_{2} + {v}_{1} ) ( y ) + {Z}_{0 -} ( {v}_{2} - {v}_{1} ) ( y ) ] {\sum }_{l = - ∞}^{∞} δ ( y - ld ) , \qquad ( 14 )$$

$$where$$

$${ℒ}_{j} w ( y ) = {D}_{j} {w}^{′′′′} ( y ) - {m}_{j} {ω}^{2} w ( y ) ,$$

$$j = 1 , 2.$$

The stiffness impedance Z₀₋ defines the force between the plates that depends on their relative separation, while Z₀₊ is a mass impedance that depends on the motion of the rib center of mass. Two models for Z_{0±} are provided in more detail below with respect to section 8. Substituting the Poisson summation identity yields:

$${\sum }_{l = - ∞}^{∞} δ ( y - ld ) = \frac{1}{d} {\sum }_{m = - ∞}^{∞} {e}^{- i 2 π m \frac{y}{d}} \qquad ( 15 )$$

and taking the ξ transform of (13) and (14) gives

$${\hat{V}}_{1} ( ξ ) = - ( {q}_{+} ( ξ ) - {q}_{-} ( ξ ) ) {\hat{Y}}_{1} ( ξ ) + 4 {π p}_{0} {\hat{Y}}_{1} ( {k}_{0} ) δ ( ξ - {k}_{0} ) , \qquad ( 16 )$$

$${\hat{V}}_{2} ( ξ ) = - ( {q}_{+} ( ξ ) + {q}_{-} ( ξ ) ) {\hat{Y}}_{2} ( ξ ) ,$$

$$where$$

$${q}_{\pm } ( ξ ) = \frac{{Z}_{0 \pm }}{d} {\sum }_{m = - ∞}^{∞} ( {\hat{V}}_{2} ( ξ + \frac{2 π m}{d} ) \pm {\hat{V}}_{1} ( ξ + \frac{2 π m}{d} ) ) , \qquad ( 17 )$$

$$with admittances$$

$${\hat{Y}}_{j} ( ξ ) = \{ {\hat{Z}}_{pj} ( ξ ) + {{\hat{Z}}_{fj} ( ξ )}^{- 1} , \qquad ( 18 )$$

$$j = 1 , 2 ,$$

$$and plate impedances$$

$${\hat{Z}}_{pj} ( ξ ) = \frac{{D}_{j} {ξ}^{4} - {m}_{j} {ω}^{2}}{- i ω} , \qquad ( 19 )$$

$$j = 1 , 2.$$

The latter are based on the Kirchhoff plate theory. Mindlin plate theory is an alternative and arguably more accurate model but not expected to provide a noticeable difference.

Noting that the functions q_{±} are periodic,

$${q}_{\pm } ( ξ ) = {q}_{\pm } ( ξ + \frac{2 π m}{d} )$$

for integer m, it follows from Eqs. (16) and (17) that

$$( \begin{matrix}{q}_{+} ( ξ ) \\ {q}_{-} ( ξ )\end{matrix} ) = \frac{4 {π p}_{0} {\hat{Y}}_{1} ( {k}_{0} )}{1 + ( \frac{d}{{Z}_{0 +}} - \frac{d}{{Z}_{0 -}} ) {\hat{Z}}_{0} ( {k}_{0} )} ( \begin{matrix}{\hat{Z}}_{+} ( {k}_{0} ) + 2 {\hat{Z}}_{0} ( {k}_{0} ) \\ - {\hat{Z}}_{-} ( {k}_{0} )\end{matrix} ) {\sum }_{m = - ∞}^{∞} δ ( ξ - {k}_{0} - \frac{2 π m}{d} ) \qquad ( 20 )$$

$$where$$

$${\hat{Z}}_{-} ( ξ ) = {\{ \frac{d}{{Z}_{0 -}} + 2 {\hat{S}}_{1} ( ξ ) \}}^{- 1} , \qquad ( 21 )$$

$${\hat{Z}}_{+} ( ξ ) = {\{ \frac{d}{{Z}_{0 +}} + 2 {\hat{S}}_{2} ( ξ ) \}}^{- 1} ,$$

$${\hat{Z}}_{0} ( ξ ) = {\hat{Z}}_{+} ( ξ ) {\hat{Z}}_{-} ( ξ ) ( {\hat{S}}_{2} ( ξ ) - ( {\hat{S}}_{1} ( ξ ) ) and$$

$${\hat{S}}_{j} ( ξ ) = {\sum }_{m = - ∞}^{∞} {\hat{Y}}_{j} ( ξ + \frac{2 π m}{d} ) , \qquad ( 22 )$$

$$j = 1 , 2.$$

### 4.2 Reflected and Transmitted Waves

Equations (10), (16) and (20) together yield the scattered pressure on either side, as follows:

$${p}_{j} ( x , y ) = 2 {p}_{0} {\hat{A}}_{j} ( {k}_{0} ) {\sum }_{m = - ∞}^{∞} {\hat{Z}}_{fj} ( {ξ}_{m} ) {\hat{Y}}_{j} ( {ξ}_{m} ) {e}^{i ( {( - 1 )}^{j} {( {k}_{1 x} )}_{m} x + {ξ}_{m} y )} - 2 {p}_{0} {\hat{Z}}_{f 1} ( {k}_{0} ) {\hat{Y}}_{1} ( {k}_{0} ) {e}^{{k}_{1} ( - {x cos θ}_{1} + {y sin θ}_{1} )} {δ}_{j 1} , j = 1 , 2 , \qquad ( 23 )$$

$$where$$

$${\hat{A}}_{1} ( ξ ) = \frac{( {\hat{Z}}_{+} ( ξ ) + \hat{{Z}_{-}} ( ξ ) + 2 {\hat{Z}}_{0} ( ξ ) )}{1 + ( \frac{d}{{Z}_{0 +}} - \frac{d}{{Z}_{0 -}} ) {\hat{Z}}_{0} ( ξ )} {\hat{Y}}_{1} ( ξ ) , \qquad ( 24 )$$

$${\hat{A}}_{2} ( ξ ) = \frac{{\hat{Z}}_{+} ( ξ ) \hat{{Z}_{-}} ( ξ ) {\hat{Y}}_{1} ( ξ )}{{( \frac{d}{{Z}_{0 +}} - \frac{d}{{Z}_{0 -}} )}^{- 1} + {\hat{Z}}_{0} ( ξ )} ,$$

$$and$$

$${ξ}_{m} = {k}_{0} + 2 π \frac{m}{d} , {( {k}_{j x} )}_{m} = \sqrt{{k}_{j}^{2} - {ξ}_{m}^{2}} for m ∈ ℤ . \qquad ( 25 )$$

Assume that only the fundamental m=0 scattered modes propagate in air and water. All other Bragg wavenumbers in the x direction, (kⱼₓ)ₘ, m≠0, are positive imaginary, leading to evanescent acoustic fields. For normal incidence this requires that k₂<27/d or equivalently fd/cₐ<1. The value of fd/cₐ does not exceed 0.2 in the numerical examples discussed below. The appearance of the periodic (Bragg) wavenumbers is expected considering that the d-periodic scatterer gives rise to waves in water and air with Bragg wavenumbers in the y and x directions, respectively.

Total pressure in the incident water (x<0) and the transmitted medium air (x>0) follows from Eqs. (12) and (23) as

$$p ( x , y ) = \{ \begin{matrix}\begin{matrix}{p}_{0} {e}^{i {k}_{1} ( {x cos θ}_{1} + {y sin θ}_{1} )} + {p}_{0} R ( {θ}_{1} ) {e}^{i {k}_{1} ( - {x cos θ}_{1} + {y sin θ}_{1} )} + \\ {p}_{1 ev} ( x , y )\end{matrix} & x < 0 , \\ {p}_{0} T ( {θ}_{2} ) {e}^{i {k}_{2} ( {x cos θ}_{2} + {y sin θ}_{2} )} + {p}_{2 e v} ( x , y ) , & x > 0 ,\end{matrix} \qquad ( 26 )$$

$$where$$

$$R ( {θ}_{1} ) = {R}_{1} ( {θ}_{1} ) + ( 1 - {R}_{1} ( {θ}_{1} ) ) {\hat{A}}_{1} ( {k}_{0} ) , \qquad ( 27 )$$

$$T ( {θ}_{2} ) = ( 1 - {R}_{2} ( {θ}_{2} ) ) {\hat{A}}_{2} ( {k}_{0} ) ,$$

R₁ and R₂ are the reflection coefficient for plane wave incidence on the plates,

$${R}_{j} ( {θ}_{j} ) = \frac{{\hat{Z}}_{pj} ( {k}_{0} ) - {\hat{Z}}_{fj} ( {k}_{0} )}{{\hat{Z}}_{pj} ( {k}_{0} ) + {\hat{Z}}_{fj} ( {k}_{0} )} , \qquad ( 28 )$$

and the evanescent, or near, fields, are

$${p}_{j e v} ( x , y ) = 2 {p}_{0} {\hat{A}}_{j} ( {k}_{0} ) {\sum }_{m \neq 0} {\hat{Z}}_{fj} ( {ξ}_{m} ) {\hat{Y}}_{j} ( {ξ}_{m} ) {e}^{i ( {( {k}_{j x} )}_{m} \vert x \vert + {ξ}_{m} y )} . \qquad ( 29 )$$

Energy conservation requires that:

$${\vert R \vert}^{2} + \frac{{Z}_{w} sec {θ}_{1}}{{Z}_{a} sec {θ}_{2}} {\vert T \vert}^{2} = 1. \qquad ( 30 )$$

Note that the reflection coefficient can be expressed in the alternative form:

$$R ( {θ}_{1} ) = \frac{{\hat{Z}}_{p {1}^{′}} ( {k}_{0} ) - {\hat{Z}}_{f 1} ( {k}_{0} )}{{\hat{Z}}_{p {1}^{′}} ( {k}_{0} ) + {\hat{Z}}_{f 1} ( {k}_{0} )} \qquad ( 31 )$$

suggestive of reflection from a plate with impedance

$${\hat{Z}}_{p 1}^{′} ( ξ ) = {\hat{Z}}_{p 1} ( ξ ) + \frac{{\hat{A}}_{1} ( ξ )}{( 1 - {\hat{A}}_{1} ( ξ ) ) {\hat{Y}}_{1} ( ξ )} . \qquad ( 32 )$$

### 5 CONDITIONS FOR FULL TRANSMISSION

Total transmission can be defined as R=0, implying two conditions for the real and imaginary parts. In order to understand these conditions, consider the case of rigid and massless ribs. This has little effect on the full solution, it significantly simplifies the algebra, allowing the determination of the “necessary” or appropriate constraints on the system parameters such that the full transmission goal is realized or at least closely realized.

As described herein with respect to the various figures, materials having specific characteristics and/or dimensions are selected to enable as full as practicable air-water or water-air acoustic transmission of wavelengths/frequencies proximate a wavelength/frequency of interest. That is, the material(s) and their characteristics and/or dimensions are selected in accordance with the determined “necessary” constraints on the system parameters.

Such constraints impact the selected thickness h₁ and a mass density p₁ of the first or water-facing of the parallel elastic plates, the thickness h₂ and a mass density p₂, of the second or air-facing of the parallel elastic plates, and the distance d between the ribs.

### 5.1 Frequency for Total Transmission

In the limit that the rib is rigid, 1/Z₀₋ →0, and massless, Z₀₊→0: Â₁(ξ)=Â₂(ξ)=Ŷ₁(ξ)/(Ŝ₁(ξ)+Ŝ₂(ξ)) and the reflection coefficient takes the form:

$$R ( {θ}_{1} ) = \frac{{R}_{1} ( {θ}_{1} ) Γ ( {k}_{0} )}{{\hat{S}}_{1} ( {k}_{0} ) + {\hat{S}}_{2} ( {k}_{0} )} \qquad ( 33 )$$

$$where$$

$$Γ ( {k}_{0} ) = {\hat{S}}_{1 ′} ( {k}_{0} ) + {\hat{S}}_{2 ′} ( {k}_{0} ) + \frac{1}{{\hat{Z}}_{p 1} ( {k}_{0} ) - {\hat{Z}}_{f 1} ( {k}_{0} )} + \frac{1}{{\hat{Z}}_{p 2} ( {k}_{0} ) + {\hat{Z}}_{f 2} ( {k}_{0} )} \qquad ( 34 )$$

$$with {\hat{S}}_{j ′} ( ξ ) = {\hat{S}}_{j} ( ξ ) - {\hat{Y}}_{j} ( ξ ) , j = 1 , 2 .$$

Total transmission corresponds to zero reflection, and the embodiments therefore look at the conditions required to make Γ and hence R vanish. Consider normal incidence, wherein k₀=0. Under these circumstances Ŝ₁,(k₀) and Ŝ₂,(k₀) are imaginary. Setting the real part of Γ(0) in (34) to zero yields the transmission frequency ω₀:

$${ω}_{0}^{2} = \frac{{Z}_{w} {Z}_{a} ( {Z}_{w} - {Z}_{a} )}{{Z}_{w} {m}_{2}^{2} - {Z}_{a} {m}_{1}^{2}} . \qquad ( 35 )$$

$$Equivalently ,$$

$${ω}_{0} = \frac{\sqrt{{Z}_{w} {Z}_{a}}}{{m}_{2}} {( \frac{1 - ϵ}{1 - ϵ {m}_{1}^{2} / {m}_{2}^{2}} )}^{1 / 2} \qquad ( 36 )$$

where ∈«1 is defined in (3). This provides the remarkable simplification

$${ω}_{0} \approx \frac{{Z}_{e}}{{m}_{2}} where {Z}_{e} ≡ \sqrt{{Z}_{w} {Z}_{a}} , \qquad ( 37 )$$

which is a very accurate approximation to Eq. (36) due to smallness of ∈.

An alternative and simpler method is presented in section 9 for finding the frequency of full transmission, Eq. (35).

### 5.2 Optimal Rib Spacing

Setting the imaginary part of Γ(k₀) of (34) to zero at ω=ω₀ given by (37), with k₀=0 yields

$$2 {\sum }_{n = 1}^{∞} \{ {( {\hat{D}}_{1} {n}^{4} - \frac{{m}_{1}}{{m}_{2}} - \frac{{ρ}_{w} d}{{m}_{2} 2 π n} )}^{- 1} + {( {\hat{D}}_{2} {n}^{4} - 1 )}^{- 1} \} \approx 1 \qquad ( 38 )$$

$$where {\hat{D}}_{j} = \frac{{{m}_{2} ( 2 π )}^{4}}{{Z}_{e}^{2} {d}^{4}} {D}_{j} , j = 1 , 2$$

and the approximations ∈«1 and ρₐd/m₂ «1 have been used.

Equation (38) determines d if h₁ is chosen, or vice versa. For instance, if ω₀ and h₁ are chosen, along with the plate materials (e.g. both aluminum), then Eq. (37) defines h₂ and Eq. (38) determines d.

Equation (38) has a close connection with the quasistatic stiffness of the two-plate flex-layer, as will now be discussed in more detail. Ignoring the inertial terms, which is consistent with the quasistatic limit, (38) becomes

$$2 {\sum }_{n = 1}^{∞} \{ {( {\hat{D}}_{1} {n}^{4} )}^{- 1} + {( {\hat{D}}_{2} {n}^{4} )}^{- 1} \} \approx 1 ⇒ d \approx {d}_{0} \qquad ( 39 )$$

$$where$$

$${d}_{0}^{4} = \frac{720}{{Z}_{e} {ω}_{0}} {( \frac{1}{{D}_{1}} + \frac{1}{{D}_{2}} )}^{- 1} \qquad ( 40 )$$

and the identity

$${\sum }_{n = 1}^{∞} \frac{1}{{n}^{4}} = \frac{{π}^{4}}{90}$$

has been used.

The relation (39) for d can be understood in terms of the effective quasistatic stiffness κ_{eff} of the flex-layer for a symmetric plate system. In the present case the plates are different and we need to take the flexural stiffness of the plates in series, i.e.

$${κ}_{eff} = {( {κ}_{1}^{- 1} + {κ}_{2}^{- 1} )}^{- 1}$$

where κⱼ=720Dⱼ/d⁴. The connection with (39) follows from the resonance condition

$${κ}_{eff} = m {ω}_{0}^{2}$$

for effective mass m=m₂. Together with (37) this yields κ_{eff}=Zₑω₀ which then implies the relation for d according to (39).

Assuming h₁ is chosen, then d follows approximately from the estimate d₀ of Eq. (40). Various embodiments use do as an initial estimate for the solution of the nonlinear Eq. (38).

### 6 NUMERICAL DEMONSTRATIONS AND DISCUSSION

Illustrative examples are presented based on the derived equations in sections 4 and 5. In all cases both plates are Aluminum (ρₛ=2,700 kg/m 3, E=70 GPa, ν=0.334), and the thickness of plate 1 is h₁=1 mm.

### 6.1 Full Transmission

Full transmission at a given frequency f₀ requires that the lengths h₂ and d assume optimal values according to Eqs. (37) and (38). In one embodiment, the procedure followed is to choose the transmission frequency f₀, then find h₂≈Zₑ/(2πf₀ρ₂) from Eq. (37) and subsequently use this value for finding d from Eq. (38), with the initial guess d=d₀ for the solution.

We consider three different flex-layers with parameters based on the optimal values of d and h₂ for normal incidence (θ₁=0°) at transmission frequencies f₀=250 Hz (d=9.5 cm and h₂=5.78 mm), f₀=500 Hz (d=7.58 cm and h₂=2.89 mm), and f₀=1000 Hz (d=5.89 cm and h₂=1.44 mm).

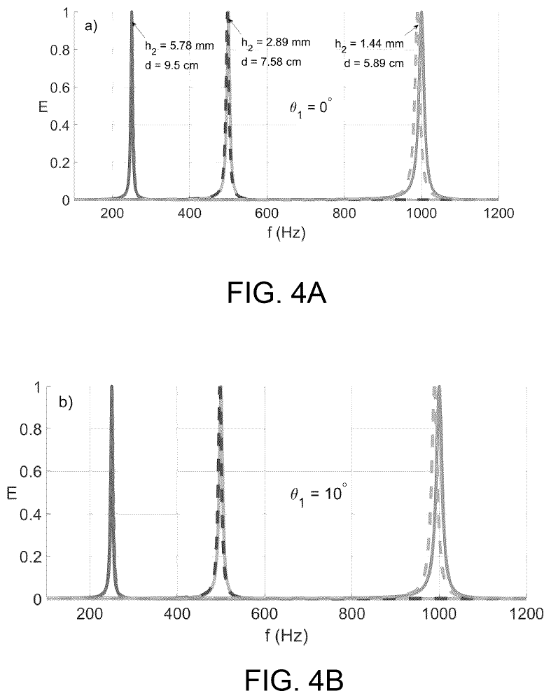

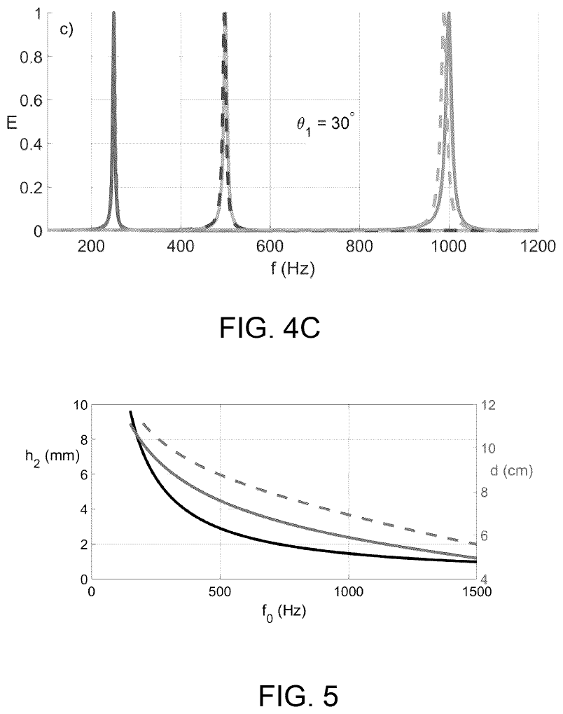

FIGS. 4A-4C graphically illustrate transmitted acoustic energy as a function of frequency for unit incident energy from the water side to the air side of various embodiments; namely, the transmitted acoustic energy

$$E = \frac{{z}_{w} sec {θ}_{1}}{{z}_{a} sec {θ}_{2}} {\vert T \vert}^{2}$$

for both normal incidence (FIG. 4A) and for incident angles θ₁=10° (FIG. 4B) and θ₁=30° (FIG. 4C).

It is evident from FIGS. 4A-4C that the optimal h₂ and d for normal incidence also work for oblique incidence, and that the full-transmission frequency is independent of θ₁ for a given optimized flex-layer.

FIG. 5 graphically illustrate the relation between f₀, h₂, and d for a range of transmission frequencies. The values of the approximate spacing d₀ is also shown, indicating that it is an overestimate of the optimal spacing for the parameter range considered.

The optimal h₂ and d in FIG. 5 are calculated for normal incidence θ₁=0°. Based on the results of FIG. 4A, it is safe to surmise that the same optimal values apply for θ₁ #0°.

### 6.2 Bandwidth and Q Factor

Now consider the effect of some system parameters on the bandwidth of the acoustic transmissivity. The parametric studies are conducted in such a way that if the same resonant frequency is desired, then changing the parameters of the first plate (i.e., water-facing plate) also changes d to maintain the equivalent bending stiffness of the first plate. Focus on full transmission at f₀=500 Hz.

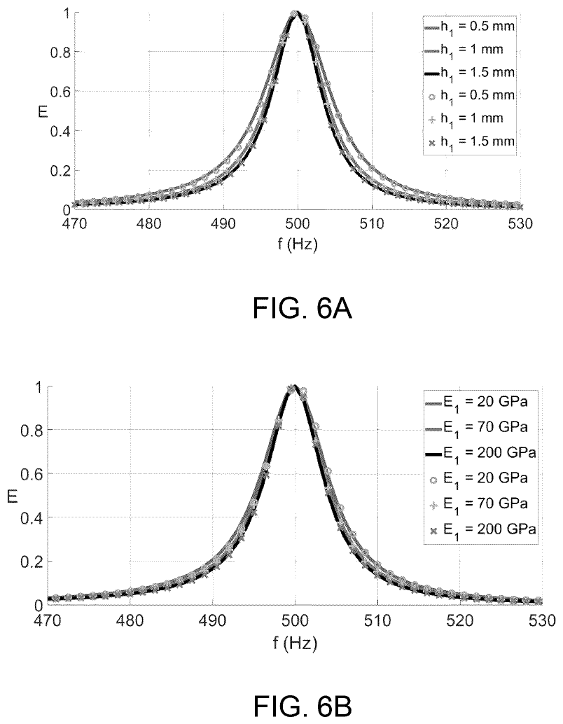

FIG. 6A graphically illustrates the impact on transmitted acoustic energy of differing thicknesses h₁ of the first or water-facing plate. For the case that h₁=1 mm, the optimal value for d is 7.58 cm, while for h₁=0.5 and 1.5 mm, the optimal values for d are 4.75 cm and 9.86 cm, respectively). The results demonstrate that h₁ has an inverse relationship with the bandwidth. Consequently, by decreasing h₁, the bandwidth increases, as depicted in FIG. 6A.

FIG. 6B graphically illustrates the impact on transmitted acoustic energy of differing Young's modulus Eᵢ of the first or water-facing plate. The next parameter we investigated to observe its effect on the bandwidth is Young's modulus of the first plate, E₁. As shown in FIG. 6B, E₁ exhibits an inverse relationship with the bandwidth (for the case that E₁=70 GPa, the optimal value for d is 7.58 cm, while for E₁=20 and 200 GPa, the optimal values for d are 5.69 cm and 9.58 cm, respectively). By comparing FIGS. 6A and 6B, it is evident that the effect of h₁ on the bandwidth is stronger than E₁.

Finally, the frequency bandwidth (BW) and Q-factor for the acoustic transmission are studied, where

$$Q = \frac{{f}_{0}}{Δ f}$$

with Δf equal to the BW at

$$E = \frac{1}{2} .$$

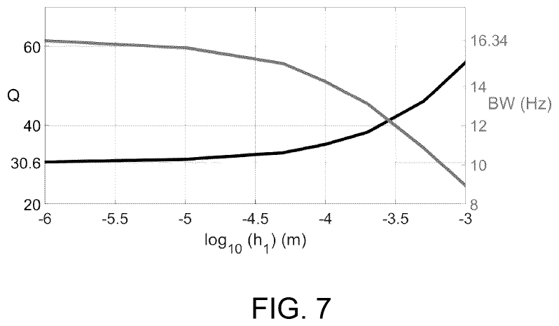

FIG. 7 graphically illustrates the effect of varying the thicknesses h₁ of the first or water-facing plate on Q-factor or bandwidth. As illustrated in FIG. 7, the Q-factor decreases with decreasing h₁, converging to

$$\frac{1}{2 \sqrt{ϵ}} \approx 30.6 ,$$

where ∈=Zₐ/Z_{w}. From the results in FIGS. 6A and 7, it is observed that by decreasing h₁, the result converges to the simple model of FIG. 2, where the Q-factor and bandwidth were found to be 30.6 and 16.34 Hz, respectively.

### 6.3 Motion of the Plates

In order to further understand the mechanics at play in the full transmission effect it is instructive to consider the motion of plates 1 and 2 facing water and air, respectively. At total transmission the energy fluxes of the incident and transmitted waves are equal. Assuming 1D propagation (as in the model of Section 2), implies p₁ν₁=p₂ν₂. Using the plane wave relations p₁=Z_{w}νᵢ and p₂=Zₐν₂ it follows that ν₁=±\sqrt{∈}ν₂ with ∈ defined in (3). We now discuss whether or not this relation is reflected in the numerical simulations. The short summary is that it is approximately, but in an averaged sense. The longer story requires some explanation.

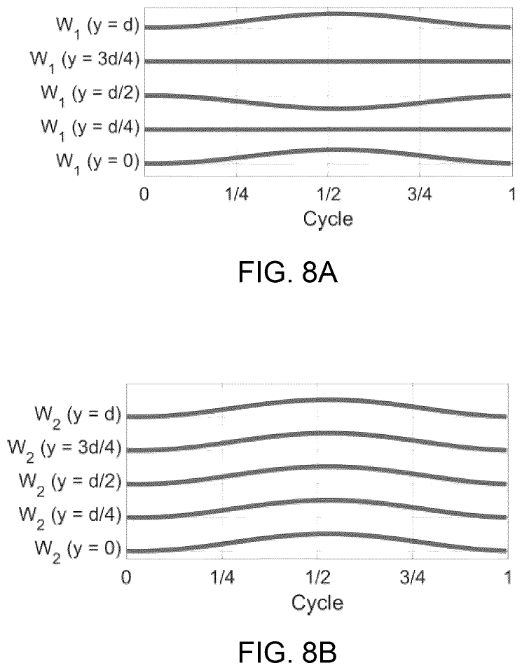

FIGS. 8A and 8B graphically illustrate plate displacements over one cycle for transmission frequency f₀=500 Hz for, respectively, first or water-facing plate and second or air-facing plate. Specifically, FIGS. 8A-8B show the plate displacements over one cycle for transmission frequency f₀=500 Hz. It is clear from the figures that plate 2 on the air side moves like a plane wave, but the same is not true for plate 1. There are significant differences in plate motion between the two plates depending on the transmission frequencies.

To better understand the dramatically different motions of the plates, it is noted that section 9 derives an alternative and reduced complexity method for finding the frequency of full transmission, Eq. (35). The method uses spatial averages of the plate displacements, w̅₁ and w̅₂. In addition to the frequency condition Eq. (35) it also follows from Eq. (61) that the average motion of plate 1 is small in comparison to that of plate 2, i.e. w̅₁≈−i\sqrt{∈}w̅₂.

We therefore have different expectations: w̅₁≈−η\sqrt{∈}w̅₂ where η can be −i, +1 or −1. We find from simulation (Comsol) that

$$\frac{{\overline{w}}_{1}}{\sqrt{ϵ} {\overline{w}}_{2}}$$

takes the values

$$1.319 {e}^{- 0.53 i \frac{π}{2}} , 1.65 {e}^{- 0.36 i \frac{π}{2}} , 1.52 {e}^{- 0.445 i \frac{π}{2}}$$

for f₀=250 Hz, 500 Hz and 1000 Hz, respectively. We conclude that none of the above are correct, although the magnitude is close, |w̅₁|≈\sqrt{∈}|ω̅₂|, indicating very little average motion of plate 1. The difference can be ascribed to the assumptions used in section 9, specifically that the pressure and velocity on plate 1 are related by the plane wave impedance relation p₁=Z_{w}ν̅₁, which is clearly not the case. Near-field evanescent effects are clearly important at plate 1 but are not included in the analysis of section 9.

Finally, we note that the mode shape of plate 1 on the water side can be accurately modeled if we ignore the effect of fluid loading and consider the plate equation only. It is clear that the mode must be symmetric in y with zero slope at

$$y = \pm \frac{d}{2} ,$$

and hence

$${w}_{1} ( y ) = {C}_{1} [ sinh ( \frac{β d}{2} ) cos ( β y ) + sin ( \frac{β d}{2} ) cosh ( β y ) ] \qquad ( 41 )$$

where

$${β}^{4} = {ω}_{0}^{2} {m}_{1} / {D}_{1} .$$

Assume that the shear force at

$$y = \pm \frac{d}{2}$$

is approximately zero

$$( i . e . , {D}_{1} {w}_{1 ′′′} ( \pm \frac{d}{2} ) \approx 0 ,$$

implying sin

$$sin ( \frac{β d}{2} ) \approx 0 ) .$$

Taking the first non-trivial solution,

$$β \approx \frac{2 π}{d} ,$$

yields the simple mode shape for some A₁:

$${w}_{1} ( y ) \approx {A}_{1} cos ( \frac{2 π}{d} y ) \qquad ( 42 )$$

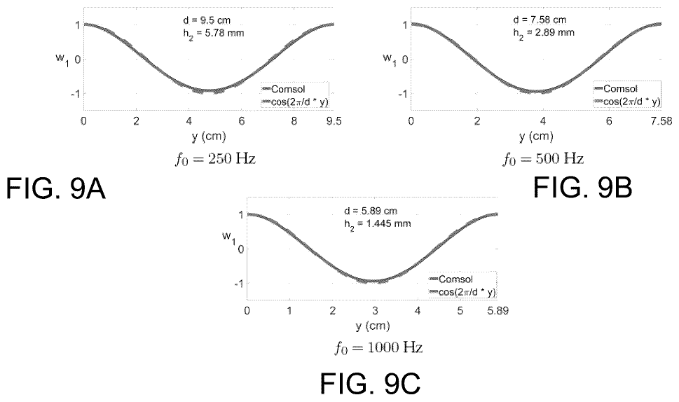

FIGS. 9A-9C graphically illustrate mode shape of the first or water-facing plate at full transmission for, respectively, transmission frequencies of 250 Hz, 500 Hz and 1000 Hz. FIGS. 9A-9C show that there is remarkable agreement between the light fluid loading model of Eq. (42) and Comsol simulations of the water-facing plate.

### 6.4 Effect of Air Between the Plates

Consider how the assumption of vacuum between the plates compares with the more realistic scenario of entrained air. The presence of air introduces an equivalent spring between the plates with stiffness κₐ similar to that in Section 2. In this case

$${κ}_{a} = {ρ}_{a} {c}_{a}^{2} / {L}_{r}$$

where Lᵣ is the rib length, i.e. the distance separating the plates. Also, based upon the previous results for the plate motions, it is clear that the relative displacement w̅₂−w̅₁ is well approximated by w̅₂. Therefore, as a first approximation assume that the effect of the air is to change the effective acceleration of plate 2 from −m₂ω²w₂ to approximately −(m₂ω²−κₐ)w₂. Using this in the derivation of (35) from (33) yields a transmission frequency ω greater than ω₀ of Eq. (7) which satisfies

$${m}_{2}^{2} {ω}^{4} - ( {Z}_{w} {Z}_{a} + 2 {m}_{2} {κ}_{a} ) {ω}^{2} + {κ}_{a}^{2} \approx 0. \qquad ( 43 )$$

$$Hence :$$

$$\frac{ω}{{ω}_{0}} \approx \frac{1}{4} + \sqrt{\frac{1}{4} + \frac{\sqrt{ϵ}}{λ}} where λ = \frac{{ω}_{0} {L}_{r}}{{c}_{a}} . \qquad ( 44 )$$

The dependence on transmission frequency and rib length combine in the single non-dimensional parameter λ.

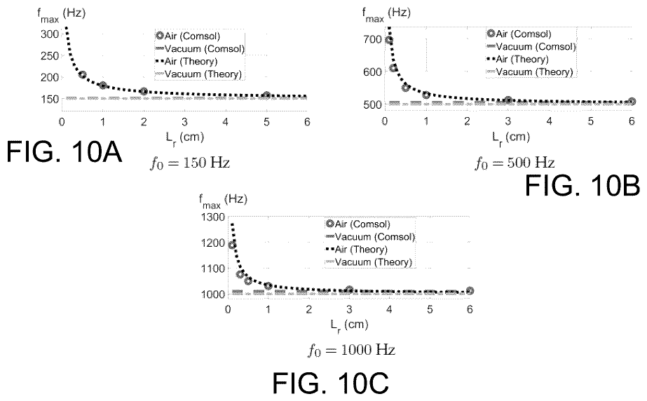

FIGS. 10A-10C graphically illustrate the effect of air between the plates as a function of rib length Lᵣ for, respectively, transmission frequencies of 250 Hz, 500 Hz and 1000 Hz. FIGS. 10A-10C demonstrate that Eq. (44) accurately predicts the effect of the presence of air on the flex-layer transmission frequency. In particular, the frequency shows an inverse relationship with the length of the ribs, indicating that shorter rib lengths result in stronger spring characteristics of the air. The resonant frequency increases as the air volume decreases and κₐ increases. However, by taking Lᵣ sufficiently long, on the order a centimeter such that λ»\sqrt{∈}, the effect of the air is negligible and the vacuum model is adequate.

### 3-PLATE EMBODIMENTS

Generally speaking, the above figures and descriptions are generally directed to the embodiments described above with respect to FIGS. 3A-3B; namely, 2-plate embodiments wherein a water-air acoustic interface panel or impedance matching system comprises two substantially parallel elastic plates of substantially the same length and width, including a water-facing plate and an air-facing plate; the water-facing plate and the air-facing plate being separated by a plurality of periodically spaced ribs disposed therebetween and extending from a front portion of a side wall to a rear portion of the side wall, the side wall enclosing the space between the water-facing plate and the air-facing plate; the water-facing plate having a thickness h₁ and a mass density ρ₁, and the air-facing plate having a thickness h₂ and a mass density ρ₂, where h₂>h₁, and ρ₁ is substantially similar to ρ₂; the periodically spaced ribs being separated from each other by a distance d, where d is selected to yield substantially full transmission of a desired frequency f₀.

In some embodiments, denoted as 3-plate embodiments, a water-air acoustic interface panel or impedance matching system comprises three parallel elastic plates of substantially the same length and width, including a water-facing plate, an air-facing plate, and a center plate disposed therebetween; a first plurality of periodically spaced ribs disposed between the water-facing plate and center plate and extending from a front portion of a side wall to a rear portion of the side wall; a second plurality of periodically spaced ribs is disposed between the center plate and air-facing plate extending from the front portion of the side wall to the rear portion of the side wall; the side wall enclosing space between the plates; the water-facing plate having a thickness h₁ and a mass density ρ₁, the air-facing plate having a thickness h₂ and a mass density ρ₂, and the center plate having a thickness h₃ and a mass density ρ₃, where h₃>>h₁>h₂, and ρ₁, ρ₂, and ρ₃ are substantially similar to each other; the periodically spaced ribs for the first plurality of ribs being separated from each other by a distance d₁, the periodically spaced ribs for the second plurality of ribs being separated from each other by a distance d₂, where d₁ and d₂ are selected to yield substantially full transmission of a desired frequency f₀. In some embodiments, d₁ is approximately equal to d₂. In some embodiments, dᵢ is approximately one-half of d₂. Other and differing ratios are contemplated, such as dᵢ is approximately one-quarter of d₂, or dᵢ is approximately one-half or more of d₂ in some portions of the array and less than one-half of d₂ in other portions of the array.

FIG. 11A depicts a side view of an air-water impedance matching system according to a modification of the embodiments discussed with respect to FIGS. 3A-3B, and FIG. 11B depicts a perspective view of an air-water impedance matching system according to the embodiments of FIG. 11A.

Generally speaking, the embodiments of FIGS. 11A-11B modify the embodiments of FIGS. 3A-3B by adding a middle or center plate between and in parallel to the water-facing and air-facing plates, and by adding a second layer of periodically spaced ribs (i.e., FIGS. 11A-11B show a first layer of ribs defining voids between the water-facing plate and the center plate, and a second layer of ribs defining voids between the center plate and the air-facing plate). As such, only the differences between the embodiments of FIGS. 11A-11B and FIGS. 3A-3B will be discussed in detail. It is noted that the above discussion of the various methods and techniques used to define and implement the embodiments of FIGS. 3A-3B are readily adapted for use in defining and implementing the embodiments of FIGS. 11A-11B

Specifically, FIGS. 11A-11B depicts an air-water impedance matching system 1100 comprising three parallel elastic plates such as aluminum plates; namely, a first or water-facing plate 1110, a second or air-facing plate 1120, and third or center plate 1130. Each of the parallel elastic plates 1110,1130,1120 is of substantially the same length and width.

The water-facing and center parallel elastic plates 1110,1130 are separated by a first plurality of periodically spaced ribs 1131 (illustratively four ribs 1131-1 through 1131-4) disposed therebetween and extending from a front portion 1140-F (not shown) of a side wall 1140 to a rear portion 1140-R (not shown) of the side wall 1140.

The center and air-facing parallel elastic plates 1130,1120 are separated by a second plurality of periodically spaced ribs 1132 (illustratively four ribs 1132-1 through 1132-4) disposed therebetween and extending from the front portion 1140-F (not shown) of the side wall 1140 to the rear portion 1140-R (not shown) of the side wall 1140.

It is noted that the sidewall 1140 may comprise a unitary sidewall encompassing the entirety of the front, rear, left, and right sides of the air-water impedance matching system 1100 of FIG. 11A-11B. In various embodiments two sidewalls may be provided, one each for the first plurality of periodically spaced ribs 1131 and second plurality of periodically spaced ribs 1132. Further, while not shown in FIGS. 11A-11B, the front 1140-F and rear 1140-R portions of the side wall(s) 1140 would be included within an actual system, apparatus, and/or device constructed in accordance with the various embodiments.

As depicted in FIG. 11A, the first 1110 of the parallel elastic plates comprises a water-facing plate having a thickness h₁ and a mass density ρ₁, the third 1130 of the parallel elastic plates comprises a center plate having a thickness h₃ and a mass density ρ₃, and the second 1120 of the parallel elastic plates comprises an air-facing plate having a thickness h₂ and a mass density ρ₂, where h₁>h₂, h₃>>h₁, and ρ₁, ρ₂, and ρ₃ are substantially similar to each other. The periodically spaced ribs for each of the first 1131 and second 1132 plurality of ribs are separated from each other by a distance d, where d is selected to yield substantially full transmission of a desired frequency f₀, as discussed in detail herein.

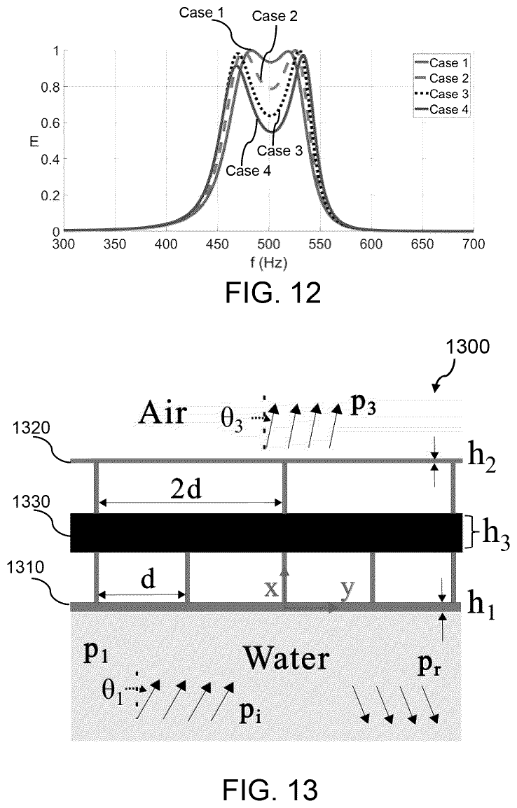

FIG. 12 graphically illustrates transmission energy ratio (E) between water and air for various cases of the embodiments discussed with respect to FIGS. 11A-11B, where f₀≈500 Hz. Specifically, FIG. 12 depicts the transmission energy ratio (E) between water and air using the three-plate configuration design of FIGS. 11A-11B wherein four optimal cases are shown for f₀≈500 Hz with various first elastic plate thicknesses h₁, second elastic plate thicknesses h₂, third elastic plate thicknesses h₃, and the periodically spaced ribs 331 being separated from each other by a distance d. All three plates 1110, 1130, and 1120 are made of Aluminum. However, as with the embodiments described above, various materials may be used alone or in any combination to construct the ribs, plates, and side walls of an impedance matching system, such as aluminum, brass, light steel, and the like, and/or rigid or semi-rigid plastics such as polycarbonate, acrylic, and the like.

It is noted that the 3-plate design of the water-air interface as described herein contains several free parameters, such as the plate thicknesses and the rib spacing—four independent quantities, in addition to the choice of material properties (density and stiffness). Numerical optimization experiments by the inventor provide that optimum transmission comprises a center plate far thicker than the ones facing water and air. This means the center plate acts as an effective mass, which allows us to recast the three-plate transformer as a two-plate model with an effective mass-like impedance between the plates. This simplification enables characterizing the transformer using asymptotic analysis based on the small parameter ∈=Zₐ/Z_{w}.

A detailed mathematical analysis of the 3-plate design, similar to that of the 2-plate one, reveals relations among the system parameters, specifically

$${m}_{2} \approx {ϵ}^{1 / 2} {m}_{3} , \qquad ( 3 P - 1 )$$

$${m}_{3} {ω}_{0}^{2} {d}^{4} \approx 720 {D}_{1} , \qquad ( 3 P - 2 )$$

$${m}_{2} {ω}_{0}^{2} {d}^{4} \approx 500 {D}_{2} , \qquad ( 3 P - 3 )$$

Combining (3P-1), (3P-2) and (3P-3) implies, assuming the same material in plates 1 and 2, that h₂≈1.129 ∈^{1/6} h₁ which for air/water translates to h₂≈0.287 h₁. If all plates have the same density the relative thicknesses are, in terms of the thickest, plate 3,

$${h}_{1} \approx 0.886 {ϵ}^{1 / 3} {h}_{3} , \qquad ( 3 P - 4 )$$

$${h}_{2} \approx {ϵ}^{1 / 2} {h}_{3} , \qquad ( 3 P - 5 )$$

which means for air/water that h₁≈0.057 h₃ and h₂≈0.016 h₃ (and h₁≈3.49 h₂).

Whether or not the materials in the plates are the same, Eqs. (3P-1), (3P-2) and (3P-3) imply that the relations between the plate thickness are independent of transmission frequency. Selecting a value for one of the three thickness then defines the other two through the asymptotic parameter ∈. The above equations also imply a relation between the plate thicknesses that is independent of the impedance ratio:

$$1.44 {h}_{1}^{3} \approx {h}_{3} {h}_{2}^{2} .$$

Further analysis, assuming the same plate density p in all plates indicates that the thickness of the central mass is well approximated as:

$${h}_{3} \approx \frac{{Z}_{w} {ϵ}^{1 / 4}}{{ρω}_{0}} , \qquad ( 3 P - 6 )$$

and the optimal rib spacing is

$$d \approx 2.542 {( \frac{{Z}_{p}}{{Z}_{e}} )}^{1 / 2} {ϵ}^{3 / 8} {h}_{3} \qquad ( 3 P - 7 )$$

where Zₑ=\sqrt{ZₐZ_{w}} is the effective transformer impedance and Zₚ=ρcₚ is the plate impedance with cₚ=\sqrt{E/ρ(1−ν²)} the plate longitudinal wave speed; for aluminum gives (Zₚ/Zₑ)^{1/2}=24.39, such that d≈2.834 h₃.

In summary, the central plate thickness depends on the frequency through Eq. (3P-6). The thicknesses of the outer plates and the rib spacing then follow from Eqs. (3P-4), (3P-5) and (3P-7).

TABLE 1

| PARAMETERS | CASE 1 | CASE 2 | CASE 3 | CASE 4 |
|---|---|---|---|---|
| Air-Facing Plate: h2 (mm) | 0.335 | 0.435 | 0.581 | 0.532 |
| Center Plate: h3 (mm) | 15.7 | 16.4 | 16.1 | 16.2 |
| Water-Facing Plate: h1 (mm) | 1.11 | 1.34 | 1.508 | 1.51 |
| Rib Spacing: d (mm) | 60.8 | 69.2 | 75.6 | 76.0 |

FIG. 13 depicts a side view of an air-water impedance matching system according to a modification of the embodiments discussed with respect to FIGS. 11A-11B. Specifically, the FIG. 13 embodiments modify the embodiments of FIGS. 11A-11B by adapting the spacing d of the ribs defining voids within either or both of the first and second plurality of ribs.

Referring to FIG. 13, it can be seen that the first (water-facing) and second (center) parallel elastic plates are separated by a first plurality of periodically spaced ribs (illustratively five ribs) disposed therebetween and extending from a front portion (not shown) of a side wall to a rear portion (not shown) of the side wall. Further, the second (center) and third (air-facing) parallel elastic plates are separated by a second plurality of periodically spaced ribs (illustratively three ribs) disposed therebetween and extending from the front portion (not shown) of the side wall to the rear portion (not shown) of the side wall.

It is noted that the five ribs of the first plurality of periodically spaced ribs are separated from each other by a distance d, whereas the second plurality of periodically spaced ribs are separated from each other by a distance of 2d.

Generally speaking, the various 3-plate embodiments described herein with respect to FIGS. 11A-11B, FIG. 13, FIG. 14, and FIG. 15 are based on the figures and descriptions directed to the embodiments described above with respect to FIGS. 3A-3B. These embodiments provide, for example, a water-air acoustic interface panel or impedance matching system comprising three parallel elastic plates of substantially the same length and width, including a water-facing plate, an air-facing plate, and a center plate disposed therebetween; a first plurality of periodically spaced ribs disposed between the water-facing plate and center plate and extending from a front portion of a side wall to a rear portion of the side wall; a second plurality of periodically spaced ribs is disposed between the center plate and air-facing plate extending from the front portion of the side wall to the rear portion of the side wall; the side wall enclosing space between the plates; the water-facing plate having a thickness h₁ and a mass density ρ₁, the air-facing plate having a thickness h₂ and a mass density ρ₂, and the center plate having a thickness h₃ and a mass density ρ₃, where h₃>>h₁>h₂, and ρ₁, ρ₂, and ρ₃ are substantially similar to each other; the periodically spaced ribs for the first plurality of ribs being separated from each other by a distance d₁, the periodically spaced ribs for the second plurality of ribs being separated from each other by a distance d₂, where d₁ and d₂ are selected to yield substantially full transmission of a desired frequency f₀. In some embodiments, d₁ is approximately equal to d₂, such as shown in FIGS. 11A-11B. In some embodiments, d₁ is approximately one half d₂, such as shown in FIG. 13. Other modifications are contemplated by the inventors.

### N-PLATE EMBODIMENTS

Still other embodiments comprise N-plate embodiments, wherein a water-air acoustic interface panel or impedance matching system comprises N parallel elastic plates of substantially the same length and width, including a water-facing plate, an air-facing plate, and N−2 center plates disposed therebetween.

In the N-plate embodiments, each pair of adjacent parallel elastic plates has disposed of therebetween a respective plurality of periodically spaced ribs extending from a front portion of a side wall to a rear portion of the side wall, the side wall, whether comprising 1, 2, 3, or any number of sidewall portions, enclosing space between the pair of adjacent plates.

At the “bottom” of a stack or formation of N plates is the water-facing plate having a thickness h₁ and a mass density ρ₁. At the “top” of the stack or formation of N plates is the air-facing plate having a thickness h₂ and a mass density ρ₂. Disposed between the water-facing plate and air-facing plate of the stack or formation of N plates comprise N−2 center plates. All of the plates may be substantially the same length and width so as to fit within a side wall common to the entirety of the stack or formation. Other embodiments are also contemplated by the inventors.

### Embodiments Using Pillars

FIG. 14 depicts a perspective view of an air-water impedance matching system according to a modification of the embodiments discussed with respect to FIGS. 3A-3B. Generally speaking, the embodiments of FIG. 14 modify the embodiments of FIGS. 3A-3B by using pillars rather than ribs to transmit acoustic energy between the water-facing and air-facing plates. As such, only the differences between the embodiments of FIG. 14 and FIGS. 3A-3B will be discussed in detail. It is noted that the above discussion of the various methods and techniques used to define and implement the embodiments of FIGS. 3A-3B are readily adapted for use in defining and implementing the embodiments of FIG. 14.

Specifically, FIG. 14 depicts an air-water impedance matching system 1400 comprising two parallel elastic plates such as aluminum plates; namely, a first or water-facing plate and a second or air-facing plate. Each of these parallel elastic plates is of substantially the same length and width.

The water-facing and air-facing plates are separated by a plurality of solid acoustic transmission mechanisms 1430 comprising periodically spaced pillars disposed therebetween and arranged as a grid or array of pillars extending from a front portion (not shown) of a side wall to a rear portion (not shown) of the side wall.

The grid or array of pillars 1430 may comprise evenly spaced pillars on each of the row and column dimensions (i.e., same distance d between rows of pillars and columns of pillars), more pillars in each row than in each column (e.g., a first distance d1 between pillars in the same row, and a second distance d2 between pillars in the same column wherein d1<d2), more pillars in each column than in each row (e.g., a first distance d1 between pillars in the same row, and a second distance d2 between pillars in the same column, wherein d1>d2), and/or some other configuration. As depicted in FIG. 14, if the grid or array of pillars is considered as a number of rows between the left and right portions of the side wall, and a number of columns between the front and rear portions of the side wall; it can be seen that the row to row spacing between pillars is d1 and the column to column spacing for pillars is d2, where d2>d1. As depicted in FIG. 14, the first of the parallel elastic plates comprises a water-facing plate having a thickness h₁ and a mass density ρ₁, while the second of the parallel elastic plates comprises an air-facing plate having a thickness h₂ and a mass density ρ₂, where h₂ is greater than h₁ and ρ₁ is substantially similar to ρ₂. The periodically spaced pillars for the plurality of ribs 1430 are separated from each other by a distance d₁ or d₂, where d₁ and d₂ are selected to yield substantially full transmission of a desired frequency f₀, as discussed in detail herein.

FIG. 15 depicts a perspective view of an air-water impedance matching system according to a modification of the embodiments discussed with respect to FIGS. 11A-11B. Generally speaking, the embodiments of FIG. 15 modify the embodiments of FIGS. 11A-11B by using pillars rather than ribs to transmit acoustic energy between the water-facing and air-facing plates, as discussed above with respect to FIG. 14. As such, only the differences between the embodiments of FIG. 15 and FIGS. 11A-11B will be discussed in detail. It is noted that the above discussion of the various methods and techniques used to define and implement the embodiments of FIGS. 11A-11B are readily adapted for use in defining and implementing the embodiments of FIG. 15.

Specifically, FIG. 15 depicts an air-water impedance matching system 1500 comprising three parallel elastic plates such as aluminum plates; namely, a first or water-facing plate, a second or air-facing plate, and third or center plate. Each of the parallel elastic plates is of substantially the same length and width.

The water-facing and center parallel elastic plates are separated by a first plurality of periodically spaced pillars 1531 disposed therebetween and arranged as a grid or array of pillars extending from a front portion (not shown) of a side wall to a rear portion (not shown) of the side wall.

The center and air-facing parallel elastic plates are separated by a second plurality of periodically spaced pillars 1532 disposed therebetween and arranged as a grid or array of pillars and extending from the front portion (not shown) of the side wall to the rear portion (not shown) of the side wall.

The grids or arrays of pillars 1531,1532 may comprise evenly spaced pillars on each of the row and column dimensions (i.e., same distance d between rows of pillars and columns of pillars), more pillars in each row than in each column (e.g., a first distance d₁ between pillars in the same row, and a second distance d2 between pillars in the same column wherein d1<d2), more pillars in each column than in each row (e.g., a first distance d1 between pillars in the same row, and a second distance d2 between pillars in the same column, wherein d1>d2), and/or some other configuration. As depicted in FIG. 15, if the grid or array of pillars is considered as a number of rows between the left and right portions of the side wall, and a number of columns between the front and rear portions of the side wall; it can be seen that the row to row spacing between pillars is d1 and the column to column spacing for pillars is d2, where d2>d1.

As depicted in FIG. 15, the first of the parallel elastic plates comprises a water-facing plate having a thickness h₁ and a mass density ρ₁, the third of the parallel elastic plates comprises a center plate having a thickness h₃ and a mass density ρ₃, and the second of the parallel elastic plates comprises an air-facing plate having a thickness h₂ and a mass density ρ₂, where h₁>h₂, h₃>>h₁, and ρ₁, ρ₂, and ρ₃ are substantially similar to each other. The periodically spaced pillars for each of the first 1531 and second 1532 plurality of ribs are separated from each other by a distance dᵢ or d₂, where d₁ and d₂ are selected to yield substantially full transmission of a desired frequency f₀, as discussed in detail herein.

The embodiments of FIGS. 14-15 as described above generally contemplate solid acoustic transmission mechanisms comprising pillars arranged in a rectilinear pattern such as an array comprising rows/column of pillars. However, embodiments other than a row/column array are contemplated, such as a circular or curved pattern or array of pillars wherein each of a plurality of pillar groups is located at a respective distance (i.e., radius) from a center of the plates, or from one or more edge portions or corner portions of the plates. In other embodiments, the solid acoustic transmission mechanisms may be distributed in a non-periodic or irregular manner or pattern.

In still other embodiments modifying any of the figures described above, different solid acoustic transmission mechanisms may be used together, such as one or more ribs and/or pillars arranged or disposed between two plates, or ribs being used between a first pair of plates (e.g., a center plate and one of the air-facing or water-facing plates) and pillars being used between a second pair of plates (e.g., the center plate and the other one of the air-facing or water-facing plates).

### 7 SUMMARY AND CONCLUSIONS (PRIMARILY 2-PLATE EMBODIMENTS)

The proposed flex-layer acts as an impedance transformer between water and air if the system parameters are chosen according to explicit criteria. Thus, for a given transmission frequency ω₀=2πf₀ the areal density m₂ of the plate facing air must satisfy Eq. (7). This defines the required thickness of the plate. A second relation, Eq. (38), defines the required rib spacing d, with d₀ of Eq. (40) an approximate over-estimate. The analytic nature of the acoustic scattering solution along with asymptotic approximations based on

$$ϵ = \frac{{Z}_{a}}{{Z}_{w}} ≪ 1$$

leads to explicit expressions such as Eq. (7) and to physical understanding such as the quite distinct motions of the two plates, described in Section 6.3. It also allows us to compare the flex-layer model with a simple spring-mass transformer defined by an effective mass m₂ and effective stiffness κ of Eq. (8).

Comparisons of the analytic solution for total transmission shows excellent agreement with full wave simulations, including for oblique incidence even though the system parameters are chosen to give full transmission for normal incidence, FIG. 4A. The effect of air between the plates is to increase the effective stiffness and increase the transmission frequency from that for a vacuum, with the simple approximation of Eq. (44) in good agreement with full wave simulations. The bandwidth of the transmission resonance depends upon the free system parameters, such as the thickness of the plate facing water. A parametric study indicates that the Q-factor has a lower achievable limit of

$$\frac{1}{2 \sqrt{ϵ}} = 30.6 ,$$

the same as the Q-factor for the ideal spring-mass model of Section 2. A reduction of the Q-factor, and associated larger bandwidth, is the subject of a separate study on an alternative transformer model.

### 8 PLATE EQUATIONS FROM HAMILTON'S PRINCIPLE

The plate equations (13) and (14) are derived here using Hamilton's principle

$$δ \int L dt = δ \int ( T - U + W ) dt = 0 \qquad ( 45 )$$

where the elements of the Lagrangian are defined by the real-valued displacements and pressure according to

$$\begin{matrix}T & = {T}_{-} + {T}_{+} + {T}_{rib} , \\ U & = {U}_{-} + {U}_{+} + {U}_{rib} , \\ W & = {W}_{-} + {W}_{+} ,\end{matrix} with \begin{matrix}{T}_{\pm } & = \int \frac{1}{2} {ρ}_{\pm } {h}_{\pm } {ω}^{2} {w}_{\pm }^{2} dy , \\ {U}_{\pm } & = \int \frac{1}{2} {D}_{\pm } {w}_{\pm , yy}^{2} dy , \\ {W}_{\pm } & = ∓ \int {p}_{\pm } {w}_{\pm } dy .\end{matrix} \qquad ( 46 )$$

Here ± indicates the contributions from the plates on x=±0. The integrals are over a single period in the y-direction that includes one rib between the plates at y=0. This formulation considers the rib as an internal member, and all external forces are contained in the W_{±} terms.

The terms T_{rib} and U_{rib} are defined by the rib model, and they depend on the plate displacements at y=0, that is w_{±}(0). Taking the variation of (45) with respect to w_{±} yields

$${ρ}_{\pm } {h}_{\pm } {ω}^{2} {w}_{\pm } - {D}_{\pm } {w}_{\pm , yyyy} ∓ {p}_{\pm } + \frac{\partial ( {T}_{rib} - {U}_{rib} )}{\partial {w}_{\pm } ( 0 )} δ ( y - 0 ) = 0. \qquad ( 47 )$$

Consider two rib models that allow expressing (T_{rib}−U_{rib}) in terms of w₊ and w₋.

### 8.1 A Mass-Spring Rib Model

The rib is a mass m with springs of stiffness 2κ on either side that attach to the plates, so the static effective stiffness is κ. This introduces the mass degree of freedom, u, its displacement in the x-direction, and

$${T}_{rib} = \frac{1}{2} m {ω}^{2} {u}^{2} , {U}_{rib} = \frac{1}{2} 2 κ [ {( u - {w}_{-} ( 0 ) )}^{2} + {( u - {w}_{+} ( 0 ) )}^{2} ] . \qquad ( 48 )$$

The variation of (45) with respect to the rib mass displacement u leads to:

$$m {ω}^{2} u - 2 κ ( 2 u - {w}_{-} ( 0 ) - {w}_{+} ( 0 ) ) = 0. \qquad ( 49 )$$

Using this to eliminate u gives:

$${T}_{rib} - {U}_{rib} = \frac{κ}{2} [ \frac{m {ω}^{2}}{4 κ - m {ω}^{2}} {( {w}_{+} ( 0 ) + {w}_{-} ( 0 ) )}^{2} - {( {w}_{+} ( 0 ) - {w}_{-} ( 0 ) )}^{2} ] . \qquad ( 50 )$$

The plate equations (4.1) then follow from (47) with:

$${Z}_{0 -} = \frac{κ}{- i ω} , {Z}_{0 +} = \frac{- i ωκ m}{4 κ - m {ω}^{2}} . \qquad ( 51 )$$

### 8.2 the Continuous Rib Model

The rib is a plate in tension/compression with parameters ρ and E located between x=−L/2 and x=L/2. The time harmonic displacement is:

$$u ( x ) = ( {w}_{+} ( 0 ) + {w}_{-} ( 0 ) ) \frac{cos kx}{2 cos k \frac{L}{2}} + ( {w}_{+} ( 0 ) - {w}_{-} ( 0 ) ) \frac{sin kx}{2 sin k \frac{L}{2}} \qquad ( 52 )$$

$$where$$

$$k = ω / c , c = \sqrt{E / ρ} ,$$

$$and$$

$${T}_{rib} = {\int }_{- \frac{L}{2}}^{\frac{L}{2}} \frac{1}{2} ρ h {ω}^{2} {u}^{2} dx , {U}_{rib} = {\int }_{- \frac{L}{2}}^{\frac{L}{2}} \frac{1}{2} Eh {u}_{, x}^{2} dx . \qquad ( 53 )$$

$$Hence ,$$

$${T}_{rib} - {U}_{rib} = \frac{1}{4} khE [ {( {w}_{+} ( 0 ) + {w}_{-} ( 0 ) )}^{2} tan k \frac{L}{2} - {( {w}_{+} ( 0 ) - {w}_{-} ( 0 ) )}^{2} cot k \frac{L}{2} ] , \qquad ( 54 )$$

and the plate equations (4.1) follows from (47) with impedances:

$$\begin{matrix}{Z}_{0 -} = i ρ c \frac{h}{2} cot \frac{kL}{2} , & {Z}_{0 +} = - i ρ c \frac{h}{2} tan \frac{kL}{2}\end{matrix} . \qquad ( 55 )$$

The above equations/conditions are consistent with the spring-mass model for

$$κ = \frac{Eh}{L}$$

and m=ρhL, as expected for the low frequency regime. Note that

$${Z}_{0 -} {Z}_{0 +} = {( ρ c \frac{h}{2} )}^{2}$$

which is independent of frequency.

### 9 ALTERNATIVE DERIVATION OF THE TRANSMISSION FREQUENCY (PRIMARILY 2-PLATE EMBODIMENTS)

Provided herein is an alternative way to arrive at the relation (35) for the frequency at full transmission. The derivation does not use infinite sums or explicit solutions in the acoustic media but relies on the plate equations only.

Consider a unit period of the layer, FIG. 3A-3B. The pressure p₂ in the fluid above the layer, air, acts as a plane wave with particle averaged velocity ν̅₂ where p₂=Zₐν̅₂. At total transmission, the pressure p₁ in the water below the layer is also a wave in one direction because of zero reflection, and accordingly p₁=Z_{w}ν̅₁. Also include the air between the plates which acts as a spring of stiffness

$${κ}_{a} \approx \frac{{ρ}_{a} {c}_{a}^{2}}{{L}_{r}}$$

due to the compressibility of the air, where Lᵣ is the plate spacing. The plate equations are then

$${D}_{j} {w}_{j ′ ′ ′ ′} ( y ) - {m}_{j} {ω}^{2} {w}_{j} = {( - 1 )}^{j} [ - {Z}_{j} {\overline{v}}_{j} + {κ}_{a} ( {\overline{w}}_{1} - {\overline{w}}_{2} ) ] , j = 1 , 2 , \qquad ( 56 )$$

$$where$$

$${Z}_{1} = {Z}_{w} , {Z}_{2} = {Z}_{a} .$$

$$Using$$

$$v = - i ω w yields$$

$${w}_{j} ( y ) = {w}_{j}^{( 0 )} {u}_{j} ( y ) + \frac{{( - 1 )}^{j}}{{ω}^{2} {m}_{j}} [ - i ω {Z}_{j} {\overline{w}}_{j} + {κ}_{a} ( {\overline{w}}_{2} - {\overline{w}}_{1} ) ] , j = 1 , 2 , \qquad ( 57 )$$

where uⱼ(y) are solutions to the homogeneous equations (56) normalized such that

$${u}_{j} ( \frac{d}{2} ) = 1.$$

The precise form of these solutions is not known since the force acting at the rib at

$$y = \frac{d}{2}$$

is unknown, except for the fact the forces are equal and opposite on the two ribs. However, a useful result is still found without knowing u₁ and u₂.

The solutions (57) satisfy two conditions. The first is the kinematic constraint

$${w}_{1} ( \frac{d}{2} ) = {w}_{2} ( \frac{d}{2} ) implying \qquad ( 58 )$$

$${w}_{1}^{( 0 )} + \frac{i ω {Z}_{w} {\overline{w}}_{1} + {κ}_{a} ( {\overline{w}}_{1} - {\overline{w}}_{2} )}{{ω}^{2} {m}_{1}} = {w}_{2}^{( 0 )} + \frac{- i ω {Z}_{a} {\overline{w}}_{2} + {κ}_{a} ( {\overline{w}}_{2} - {\overline{w}}_{1} )}{{ω}^{2} {m}_{2}} .$$

The displacements

$${w}_{j}^{( 0 )}$$

can be related to w̅ⱼ by taking the average of (57), so that (58) becomes:

$$( 59 )$$

$$[ \frac{i ω {Z}_{w}}{{m}_{1}} ( 1 - \frac{1}{{\overline{u}}_{1}} ) + \frac{{ω}^{2}}{{\overline{u}}_{1}} + \frac{{κ}_{a} γ}{{m}_{1} {m}_{2}} ] {\overline{w}}_{1} + [ \frac{i ω {Z}_{a}}{{m}_{2}} ( 1 - \frac{1}{{\overline{u}}_{2}} ) - \frac{{ω}^{2}}{{\overline{u}}_{2}} - \frac{{κ}_{a} γ}{{m}_{1} {m}_{2}} ] {\overline{w}}_{2} = 0$$

$$where$$

$$γ = {m}_{1} + {m}_{2} - \frac{{m}_{1}}{{\overline{u}}_{2}} - \frac{{m}_{2}}{{\overline{u}}_{1}} . \qquad ( 60 )$$

The second condition is that the shear forces acting at the ribs are equal and opposite:

$${D}_{1} {w}_{1 ′′′} ( \frac{d}{2} ) + {D}_{2} {w}_{2 ′′′} ( \frac{d}{2} ) = 0.$$

The latter is equivalent, by integration from 0 to d/2, to taking the average of the sum of the two equations (56), i.e.

$$( {Z}_{w} + i ω {m}_{1} ) {\overline{w}}_{1} = ( {Z}_{a} - i ω {m}_{2} ) {\overline{w}}_{2} . \qquad ( 61 )$$

Equations (59) and (61) are then a pair of linear and homogeneous equations in w̅₁ and w̅₂. In order that non-trivial solutions are possible the determinant must be zero, i.e.

$$( \frac{{Z}_{w}}{{m}_{1}} - \frac{{Z}_{a}}{{m}_{2}} ) {ω}^{2} γ - ( {Z}_{w} - {Z}_{a} ) ( {ω}^{2} + \frac{{κ}_{a} γ}{{m}_{1} {m}_{2}} ) + i ω \{ ( {ω}^{2} + \frac{{Z}_{a} {Z}_{w}}{{m}_{1} {m}_{2}} ) γ - ( {m}_{1} + {m}_{2} ) ( {ω}^{2} + \frac{{κ}_{a} γ}{{m}_{1} {m}_{2}} ) \} = 0 \qquad ( 62 )$$

The transmission frequency ω₀ follows from (62) in the same form as (35), independent of the air layer stiffness κₐ.

In summary, the identity (35) has been deduced using a lumped parameter model combined with the plate equations for one spatial period.

Thus, various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory or stored within a memory within a computing device operating according to the instructions.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. An apparatus for acoustic transmission between water and air, comprising:
two substantially parallel elastic plates of substantially the same length and width, including a water-facing plate and an air-facing plate;
the water-facing plate and the air-facing plate being separated by a plurality of periodically spaced solid acoustic transmission mechanisms disposed therebetween and extending from a front portion of a side wall to a rear portion of the side wall, the side wall enclosing the space between the water-facing plate and the air-facing plate;
the water-facing plate having a thickness h₁ and a mass density ρ₁, and the air-facing plate having a thickness h₂ and a mass density ρ₂, where h₂>h₁, and ρ₁ is substantially similar to ρ₂;
the periodically spaced solid acoustic transmission mechanisms being separated from each other by a distance d, where d is selected to yield substantially full transmission of a desired frequency f₀.

2. The apparatus of claim 1, wherein the solid acoustic transmission mechanisms comprise ribs.

3. The apparatus of claim 1, wherein the solid acoustic transmission mechanisms comprise rows of pillars.

4. The apparatus of claim 2, wherein intermediate spaces between adjacent ribs comprise sealed spaces containing air at a nominal atmospheric pressure.

5. The apparatus of claim 2, wherein intermediate spaces between adjacent ribs comprise sealed space containing air at a reduced atmospheric pressure.

6. The apparatus of claim 1, wherein the parallel elastic plates comprise aluminum plates.

7. The apparatus of claim 1, wherein the parallel elastic plates comprise one of aluminum plates, brass plates, light steel plates, rigid plastic plates, and semi-rigid plastic plates.

8. The apparatus of claim 1, wherein for the desired transmission frequency f₀ the thickness of the air-facing plate having a thickness h₂ is determined as h₂≈Zₑ/(2πf₀ρₛ₂).

9. The apparatus of claim 6, wherein the spacing distance d is determined in accordance with:
$$κ {m}_{2} \approx {Z}_{a} {Z}_{w}$$
$$where$$
$$κ = \frac{720}{{d}^{4}} {( \frac{1}{{D}_{1}} + \frac{1}{{D}_{2}} )}^{- 1} ..$$

10. An apparatus for acoustic transmission between water and air, comprising:
three parallel elastic plates of substantially the same length and width, including a water-facing plate, an air-facing plate, and a center plate disposed therebetween;
a first plurality of periodically spaced solid acoustic transmission mechanisms disposed between the water-facing plate and center plate and extending from a front portion of a side wall to a rear portion of the side wall;
a second plurality of periodically spaced solid acoustic transmission mechanisms is disposed between the center plate and air-facing plate extending from the front portion of the side wall to the rear portion of the side wall;
the side wall enclosing space between the plates;
the water-facing plate having a thickness h₁ and a mass density ρ₁, the air-facing plate having a thickness h₂ and a mass density ρ₂, and the center plate having a thickness h₃ and a mass density ρ₃, where h₃>>h₁>h₂, and ρ₁, ρ₂, and ρ₃ are substantially similar to each other;
the first plurality of periodically spaced solid acoustic transmission mechanisms being separated from each other by a distance d₁,
the second plurality of periodically spaced solid acoustic transmission mechanisms being separated from each other by a distance d₂, where d₁ and d₂ are selected to yield substantially full transmission of a desired frequency f₀.

11. The apparatus of claim 10, wherein the solid acoustic transmission mechanisms comprise ribs.

12. The apparatus of claim 10, wherein the solid acoustic transmission mechanisms comprise rows of pillars.

13. The apparatus of claim 10, wherein one of the first and second pluralities of periodically spaced solid acoustic transmission mechanisms comprise rows of pillars, and the other of the first and second pluralities of periodically spaced solid acoustic transmission mechanisms comprise ribs.

14. The apparatus of claim 10, wherein d₁ is approximately equal to d₂.

15. The apparatus of claim 10, wherein d₁ is approximately one half d₂.

16. The apparatus of claim 10, wherein the side wall comprises a first sidewall portion configured to enclose the space between the water-facing plate and center plate, and a second sidewall portion configured to enclose the space between the center plate and the air-facing plate.

17. The apparatus of claim 10, wherein intermediate spaces between adjacent plurality of periodically spaced solid acoustic transmission mechanisms comprise sealed spaces containing air at a nominal atmospheric pressure.

18. The apparatus of claim 10, wherein intermediate spaces between adjacent ribs comprise sealed space containing air at a reduced atmospheric pressure.

19. The apparatus of claim 10, wherein the parallel elastic plates comprise aluminum plates.

20. The apparatus of claim 1, wherein the parallel elastic plates comprise one of aluminum plates, brass plates, light steel plates, rigid plastic plates, and semi-rigid plastic plates.
